(19) United States
(12) Patent Application Publication
(10) Pub. No.: US 2025/0321319 A1
(43) Pub. Date: Oct. 16, 2025

(54) A METHOD, DEVICE AND SYSTEM FOR RAPID MULTI-SENSOR CALIBRATION OF COOPERATIVE VEHICLE-INFRASTRUCTURE SYSTEMS

(71) Applicant: Cong ZHAO, Shanghai (CN)

(72) Inventors: Cong ZHAO, Shanghai (CN); Yuchuan Du, Shanghai (CN); Delong Ding, Shanghai (CN); Shiyu Wang, Shanghai (CN); Lu Gan, Shanghai (CN); Yuxiong JI, Shanghai (CN)

(21) Appl. No.: 18/862,961

(22) PCT Filed: Jan. 4, 2024
(86) PCT No.: PCT/CN2024/070503

§ 371 Date: Nov. 15, 2024

(30) Foreign Application Priority Data
Jan. 6, 2023 (CN) 202310021057.9

(51) Int. Cl. G01S 7/40; G01S 13/931; G08G 1/04

(52) U.S. Cl. CPC G01S 7/40; G01S 13/931; G08G 1/04

(57) ABSTRACT

The present invention introduces a method, device and system for rapid multi-sensor calibration of cooperative vehicle-infrastructure systems. The method includes the following steps: calibration data collection, vehicle-infrastructure trajectory data matching and calibration parameter calculation. A connected vehicle collects a vehicle-side positioning data and a vehicle-side perception data. Roadside perception devices collect an infrastructure-side perception data. An infrastructure-side positioning data is obtained from the vehicle-side positioning data, vehicle-side perception data and the infrastructure-side perception data. A calibration parameter is calculated from the vehicle-side positioning data and infrastructure-side positioning data. Building on this method, the invention presents a device and system for rapid multi-sensor calibration of cooperative vehicle-infrastructure systems. The system involves two modules and a platform: a vehicle-side module, an infrastructure-side module and a calibration platform. Compared to existing technologies, the present invention can achieve fast and automatic multi-sensor calibration.

### FIELD OF INVENTION

The invention relates to the technical field of traffic information collection and processing, specifically to a method, device and system for rapid multi-sensor calibration of cooperative vehicle-infrastructure systems. It is primarily focused on the construction, operation, and maintenance of multi-source perception systems in road environments under vehicle-infrastructure collaboration.

### BACKGROUND OF THE INVENTION

With the rapid development of sensing and communication technologies, the intelligent construction of highways and urban roads is unfolding at a vigorous pace. A large number of intelligent sensing sensors, such as high-definition video cameras, millimeter-wave radars, and LiDAR, have been deployed in road areas. These intelligent sensing sensors are core components of vehicle-infrastructure collaboration and smart highway scenarios. Building a comprehensive multi-sensor perception system for vehicle-infrastructure collaboration has become a crucial direction for the future development of autonomous driving.

Intelligent sensing sensors possess sensing, communication, and edge computing capabilities. Through target recognition, tracking, and data fusion technologies, these devices can collect information about vehicle contours, positions, speeds, accelerations, and more. This enables dynamic perception of the traffic environment, covering all aspects and elements, compensating for the limitations of perception range on autonomous vehicles, and supporting the implementation of functions in vehicle-infrastructure collaboration systems.

However, the data collected by different sensors often use their own independent coordinate systems (such as radar coordinate systems or pixel coordinate systems), and there are usually time discrepancies between the systems of different sensors. To achieve fine-grained data fusion across multiple sensors in vehicle-infrastructure systems, it is necessary to calibrate the external parameters of roadside sensors, obtain the transformation matrices between different coordinate systems, and determine system delay parameters. This ensures that data collected by various sensors in a region are unified under the same spatiotemporal coordinate system (such as latitude and longitude coordinates or reference plane coordinates).

In the context of widespread deployment of roadside sensing devices, spatiotemporal adaptive registration needs to be re-executed when sensors are installed for the first time, replaced due to damage, or installed insecurely. Additionally, as the requirements for real-time and accuracy of roadside perception data in vehicle-infrastructure collaboration applications continue to increase, any failure to update the spatiotemporal parameters of roadside sensors promptly can lead to perception failures, resulting in decision-making errors and potential safety hazards. Therefore, how to achieve rapid spatiotemporal calibration of multiple sensors has become an urgent problem to solve in the construction of vehicle-infrastructure collaboration systems.

To achieve sensor calibration, traditional methods generally use customized calibration targets. By placing fixed calibration objects in specific areas or making the target perform specific movements, the sensors to be calibrated can collect positioning data from different points, enabling the calculation of calibration parameters. For the selection of calibration objects, commonly used items in road camera sensor calibration include checkerboard grids and spheres, which have clear edges and prominent visual features. In radar calibration, corner reflectors are often used due to their high surface reflectivity, providing accurate reflection signals even in distant, low-light, or complex environments.

Once the positions of the calibration objects in both the world coordinate system and the sensor data coordinate system are collected, traditional methods determine the mapping relationship between the two coordinate systems by identifying corresponding data points. This is done using techniques such as direct linear transformation, three-point perspective, rigid body transformation, and intrinsic matrix transformation to project world coordinates into the sensor data coordinate system. After establishing the coordinate correspondence, the calibration parameters can be modeled and optimized using methods such as the least squares approach, solving for spatiotemporal parameters to minimize projection error between corresponding points. Common optimization algorithms include the Gauss-Newton method and the Levenberg-Marquardt method.

However, these methods require ideal detection conditions to ensure the calibration target is reliably recognized by the sensor. When traffic volume is high, the complexity of the sensing scene increases, making it difficult to reliably identify the customized target. It becomes especially challenging to track vehicles equipped with positioning devices within the multi-target trajectory data output by roadside sensors, particularly when the sensors only provide target-level vehicle perception data. To ensure reliable parameter calibration, the process often needs to be conducted under closed road conditions or during low traffic volumes, allowing for accurate identification of the objects used in calibration.

On the other hand, traditional multi-sensor spatiotemporal synchronization methods typically synchronize sensor clocks first and then calibrate the spatial parameters of each sensor. However, in large-scale roadside deployments of multi-sensor systems, clock synchronization systems can be very costly. In systems without clock synchronization, the data collected by roadside sensors not only exist in different spatial coordinate systems but also have varying system delays. Traditional calibration methods that only calibrate spatial parameters suffer from reduced accuracy due to these delays, leading to poor spatiotemporal synchronization across multiple roadside sensors.

Therefore, the key challenge in achieving spatiotemporal adaptive registration of multiple sensors lies in accurately and quickly identifying vehicles for calibration without disrupting traffic, and in precisely estimating spatiotemporal transformation parameters under asynchronous conditions.

To achieve sensor calibration, traditional methods generally use customized calibration targets. By placing fixed calibration objects in specific areas or making the target perform specific movements, the sensors to be calibrated can collect positioning data from different points, enabling the calculation of calibration parameters. For the selection of calibration objects, commonly used items in road camera sensor calibration include checkerboard grids and spheres, which have clear edges and prominent visual features. In radar calibration, corner reflectors are often used due to their high surface reflectivity, providing accurate reflection signals even in distant, low-light, or complex environments.

Once the positions of the calibration objects in both the world coordinate system and the sensor data coordinate system are collected, traditional methods determine the mapping relationship between the two coordinate systems by identifying corresponding data points. This is done using techniques such as direct linear transformation, three-point perspective, rigid body transformation, and intrinsic matrix transformation to project world coordinates into the sensor data coordinate system. After establishing the coordinate correspondence, the calibration parameters can be modeled and optimized using methods such as the least squares approach, solving for spatiotemporal parameters to minimize projection error between corresponding points. Common optimization algorithms include the Gauss-Newton method and the Levenberg-Marquardt method.

However, these methods require ideal detection conditions to ensure the calibration target is reliably recognized by the sensor. When traffic volume is high, the complexity of the sensing scene increases, making it difficult to reliably identify the customized target. It becomes especially challenging to track vehicles equipped with positioning devices within the multi-target trajectory data output by roadside sensors, particularly when the sensors only provide target-level vehicle perception data. To ensure reliable parameter calibration, the process often needs to be conducted under closed road conditions or during low traffic volumes, allowing for accurate identification of the objects used in calibration.

On the other hand, traditional multi-sensor spatiotemporal synchronization methods typically synchronize sensor clocks first and then calibrate the spatial parameters of each sensor. However, in large-scale roadside deployments of multi-sensor systems, clock synchronization systems can be very costly. In systems without clock synchronization, the data collected by roadside sensors not only exist in different spatial coordinate systems but also have varying system delays. Traditional calibration methods that only calibrate spatial parameters suffer from reduced accuracy due to these delays, leading to poor spatiotemporal synchronization across multiple roadside sensors.

Therefore, the key challenge in achieving spatiotemporal adaptive registration of multiple sensors lies in accurately and quickly identifying vehicles for calibration without disrupting traffic, and in precisely estimating spatiotemporal transformation parameters under asynchronous conditions.

### PRIOR ART

Patent document WO2018103407
Patent document CN110390697B
Patent document CN113465608A
Patent document CN111754581A
Patent document WO2022141914

### Terminology

1. Collaborative perception: using wireless communication technology to enable the interaction of information between vehicles and infrastructure, enhancing the performance of perception tasks.
2. Roadside perception devices: Sensors installed along roadways to monitor traffic conditions, vehicles, and other road users, including radar, lidar and camera, collecting raw perception data.
3. Calibration parameter: including spatial parameters and temporal parameters. Temporal parameters refer to the clock shift between different sensors. Spatial parameters refer to the coordinate transformation parameters, including rotation angle and translation vector.
4. Rapid multi-sensor calibration: determining the spatial and temporal parameters, synchronizing data from multiple sources in spatiotemporal coordinates.
5. Connected vehicle: vehicle used to collect calibration data. A connected vehicle should be equipped with onboard positioning devices, onboard perception devices and onboard communication devices, collecting vehicle-side positioning data and vehicle-side perception data.
6. Calibration data: including infrastructure-side perception data ^{I} [symbol] , vehicle-side positioning data ^{v}S and vehicle-side perception data ^{v} [symbol] .
7. Onboard positioning devices: installed on a connected vehicle, obtaining vehicle positioning data ^{v}S, GNSS/IMU integrated positioning devices.
8. Onboard perception devices: installed on a connected vehicle, obtaining vehicle perception data ^{v} [symbol] , including radar, lidar and camera.
9. Communication devices: installed either on a connected vehicle or road infrastructures, sending vehicle-side positioning data, vehicle-side perception data and infrastructure-side perception data to a calibration platform.
10. Infrastructure-side perception data ⁱ [symbol] : trajectory data collected by infrastructure sensors, involving timestamps, vehicle positions, etc., using an infrastructure coordinate system \vec{F}_{R}.
11. Vehicle-side positioning data ^{v}S: trajectory data collected by onboard positioning devices, including timestamps, vehicle positions, etc., using a map coordinate system \vec{F}_{M}.
12. Vehicle-side perception data ^{v} [symbol] : trajectory data collected by onboard perception devices, including timestamps, vehicle positions, etc., using a vehicle coordinate system \vec{F}_{E}.
13. Infrastructure coordinate system \vec{F}_{R}: coordinate system used by roadside perception devices to obtain infrastructure-side perception data, generally setting the positions of installation as coordinate origins.
14. Map coordinate system \vec{F}_{M}: coordinate system used by onboard positioning devices to obtain vehicle-side positioning data, generally using the WGS84 coordinate system.
15. Vehicle coordinate system \vec{F}_{E}: coordinate system used by onboard perception devices to obtain vehicle-side perception data, generally setting the center of vehicle as coordinate origin, vehicle's heading as direction of x-axis, vehicle's left-hand side as direction of y-axis.
16. Vehicle-infrastructure trajectory matching vector x: vehicle identity correspondence registration between vehicle-side perception data and infrastructure-side perception data.
17. Infrastructure-side positioning data ⁱS: trajectory data of a connected vehicle, selected from an infrastructure-side perception data ⁱ [symbol] according to a vehicle-infrastructure trajectory matching vector.
18. Vehicle-infrastructure data delay t_{d}: clock shift between timestamps of infrastructure-side perception data and vehicle-side positioning data.
19. Synchronized infrastructure-side perception data ^{iv} [symbol] : estimation of infrastructure-side perception data ⁱ [symbol] at timestamps of vehicle-side positioning data.
20. Calibration error e: spatial shift between the vehicle-side positioning data transformed by calibration parameter and infrastructure-side positioning data.
21. Gaussian process: a random process involving series of normally distributed random variables in an exponential set.
22. Gaussian process regression: non parametric model that uses Gaussian process priors to perform regression analysis on data, realizing continuous time state estimation.
23. Trajectory feature graph: a feature sequence composed of a series of graph structures. A trajectory feature graph is defined as [symbol] ={ [symbol] , W¹, W²}. [symbol] is a vehicle identity set. [symbol] is a timestamp list. W¹ and W² are first and second order feature.
24. First order feature: feature of vertices in a trajectory feature graph, representing feature of a single vehicle target, using the normalized vehicle velocity in the present invention.
25. Second order feature: feature of edges in a trajectory feature graph, representing feature between pairs of vehicle targets, using the normalized relative vehicle location and velocity in the present invention.
26. Graduated Nonconvexity and Concavity Procedure: proposed by Liu et. al., implementing a convex-concave relaxation process without explicitly expressing the relaxation functions, using as a solver for subgraph matching problems in the present invention.
27. Hungarian algorithm: a combinatorial optimization algorithm for solving task allocation problems in polynomial time, constructed by Kuhn in 1955.
28. Line search: an iterative method of finding the minimum value of a function. For each iteration, the line search algorithm calculates the direction of the search and the step size along the direction.

### SUMMARY OF THE INVENTION

The present invention introduces a method, device and system for rapid multi-sensor calibration of cooperative vehicle-infrastructure systems. Said method includes the following steps: calibration data collection, vehicle-infrastructure trajectory data matching and calibration parameter calculation. A connected vehicle collects a vehicle-side positioning data and a vehicle-side perception data. Roadside perception devices collect an infrastructure-side perception data. An infrastructure-side positioning data is obtained from said vehicle-side positioning data, vehicle-side perception data and said infrastructure-side perception data. A calibration parameter is calculated from said vehicle-side positioning data and infrastructure-side positioning data. Building on this method, the invention presents a system for rapid multi-sensor calibration of cooperative vehicle-infrastructure systems. Said system involves two modules and a platform: a vehicle-side module, an infrastructure-side module and a calibration platform. Compared to existing technologies, the present invention can achieve fast and automatic calibration of multiple sensors.

The flowchart of said method is shown in FIG. 1 and FIG. 2, which includes three steps: calibration data collection, vehicle-infrastructure trajectory data matching, and calibration parameter calculation.

### 1. Calibration Data Collection

One or more connected vehicles equipped with onboard positioning devices and onboard perception devices drive within the field of view of said roadside perception devices. Said roadside perception devices collect infrastructure-side perception data ⁱ [symbol] in an infrastructure coordinate system \vec{F}_{R}. Said onboard positioning devices collect vehicle-side positioning data ^{v}S in a map coordinate system \vec{F}_{M}. Said onboard perception devices collect vehicle-side perception data ^{v} [symbol] in a vehicle coordinate system \vec{F}_{E}.

| Sensor | | Coordinate |
|---|---|---|
| Type | Data Definition | System |
| Roadside | Vehicle-side positioning data ^{v}S = {^{v} [symbol] , ^{v}r} ^{v} [symbol] denotes a vehicle- | Infrastructure |
| perception | side timestamp list. ^{v}r denotes a trajectory data ^{v}r = | coordinate |
| devices | {(tₗ, pₗ, vₗ) \| tₗ ∈ ^{v} [symbol] }. tₗ denotes a timestamp. pₗ and vₗ denote a | system |
| | position and velocity. | |
| Onboard | Vehicle-side perception data ^{v} [symbol] = {^{v} [symbol] , ^{v} [symbol] , ^{v} [symbol] }. ^{v} [symbol] denotes said | Map |
| positioning | vehicle-side timestamp list. ^{v} [symbol] denotes a trajectory identity set. | coordinate |
| devices | ^{v} [symbol] denotes a vehicle-side trajectory dataset ^{v} [symbol] = {(vₙ, rₙ) \| vₙ ∈ | system |
| | ^{v} [symbol] }. vₙ denotes a trajectory identity. rₙ denotes a trajectory data | |
| | rₙ = {(tₗ, pₗ, vₗ) \| tₗ ∈ ^{v} [symbol] }. tₗ denotes a timestamp. pₗ and vₗ | |
| | denote a position and velocity. | |
| Onboard | Infrastructure-side perception data ⁱ [symbol] = {ⁱ [symbol] , ⁱ [symbol] , ⁱ [symbol] }. ⁱ [symbol] denotes | Vehicle |
| perception | an infrastructure-side timestamp list. ⁱ [symbol] denotes the trajectory | coordinate |
| devices | identity set. ⁱ [symbol] denotes the infrastructure-side trajectory dataset | system |
| | ⁱ [symbol] = {(vₙ, rₙ) \| vₙ ∈ ⁱ [symbol] )}. vₙ denotes the trajectory identity. rₙ | |
| | denotes the trajectory data rₙ = {(tₗ, pₗ, vₗ) \| tₗ ∈ ⁱ [symbol] }. tₗ denotes | |
| | the timestamp. pₗ and vₗ denote the position and velocity. | |

Said map coordinate system \vec{F}_{M} is inconsistent with said infrastructure coordinate system \vec{F}_{R}; said infrastructure-side timestamp list ⁱ [symbol] and vehicle-side timestamp list ^{v} [symbol] are inconsistent.

### 2. Vehicle-Infrastructure Trajectory Data Matching

Flowchart of vehicle-infrastructure trajectory data matching is shown in FIG. 3, including continuous trajectory representation, trajectory feature graph calculation, graph matching affinity matrix calculation, and vehicle-infrastructure data registration and delay estimation.

A vehicle-infrastructure data delay t_{d} is initialized, t_{d}←0. An iteration counter c₁ is initialized. An iteration limit m₁ is initialized. ← assigns the value on the right to the variable on the left.

### 2.1. Continuous Trajectory Representation

Flowchart of continuous trajectory representation is shown in FIG. 2.

### 2.1.1. Synchronized Timestamp Calculation

A vehicle-infrastructure data delay t_{d} is set and added to said vehicle-side timestamp list ^{v} [symbol] , obtaining synchronized timestamps ^{iv} [symbol] .

$${}^{iv} 𝒯 = \{ {}^{iv} {t}_{l} {\vert}^{i v} {t}_{l} = {}^{v} {t}_{l} + {t}_{d} , {v}_{{t}_{l}} ∈ {}^{v} 𝒯 \} \qquad ( 1 )$$

^{v}tₗ denotes the timestamp for vehicle positioning data. ^{iv}tₗ denotes the timestamp for synchronized infrastructure positioning data.

### 2.1.2. Continuous Gaussian Process Modeling

A continuous motion model and a discreate observation model are built for each trajectory data rₙ in infrastructure-side perception data ⁱ [symbol] .

$$z ( t ) ∼ 𝒢𝒫 ( \check{μ} ( t ) , \check{Σ} ( t , {t}^{′} ) ) \qquad ( 2 )$$

$${y}_{l} = {C}_{l} {z}_{l} + {n}_{l} \qquad ( 3 )$$

z(t) is a state vector at timestamp t, following a Gaussian process defined by prior μ̌(t) and Σ̌(t, t′). zₗ is a state vector at the lth timestamp tₗ. yₗ is a lth observation. Cₗ is an observation matrix. nₗ is an observation noise, following zero-mean Gaussian distribution with covariance matrix Rₗ.

### 2.1.3. Prior States Calculation

An initial state mean μ₁ and a state covariance Σ₁ are set for trajectory data rₙ. Based on said continuous motion model, a prior state mean μ̌ and covariance Σ̌ at said infrastructure-side timestamp list ⁱ [symbol] are calculated. A prior state mean [symbol] and covariance [symbol] at said synchronized timestamp list ^{iv} [symbol] are calculated.

Said Gaussian process z(t) is defined as a linear differential equation.

$$\dot{z} ( t ) = B z ( t ) + u ( t ) + Z w ( t ) \qquad ( 4 )$$

B and Z are system matrices. u is an input signal. w is zero mean Gaussian process, covariance matrix of which is defined by a process noise matrix Qc.

A constant velocity model is applied in the present invention by adding zero-mean noise on modeled vehicle acceleration. A prior state mean μ̌ and covariance Σ̌ at said infrastructure-side timestamp list ⁱ [symbol] are calculated as follows.

$$\check{μ} = [ \begin{matrix}{\check{μ}}_{1} \\ Φ ( {t}_{2} , {t}_{1} ) {\check{μ}}_{1} \\ ⋮ \\ Φ ( {t}_{N} , {t}_{1} ) {\check{μ}}_{1}\end{matrix} ] , {\check{Σ}}^{- 1} = {P}^{- T} {Q}^{- 1} {P}^{- 1} \qquad ( 5 )$$

$${P}^{- 1} = [ \begin{matrix}1 & 0 & … & 0 & 0 \\ - Φ ( {t}_{2} , {t}_{1} ) & 1 & … & 0 & 0 \\ 0 & - Φ ( {t}_{2} , {t}_{1} ) & ⋱ & ⋮ & ⋮ \\ ⋮ & ⋮ & ⋱ & 1 & 0 \\ 0 & 0 & … & - Φ ( {t}_{N} , {t}_{N - 1} ) & 1\end{matrix} ] \qquad ( 6 )$$

$${Q}^{- 1} = diag ( {\check{Σ}}_{1}^{- 1} , {Q}_{1 , 2}^{- 1} , … , {Q}_{N - 1 , N}^{- 1} ) \qquad ( 7 )$$

$${Q}_{a , b}^{- 1} = [ \begin{matrix}\frac{12 {Q}_{c}^{- 1}}{{( {t}_{b} - {t}_{a} )}^{3}} & \frac{- 6 {Q}_{c}^{- 1}}{{( {t}_{b} - {t}_{a} )}^{2}} \\ \frac{- 6 {Q}_{c}^{- 1}}{{( {t}_{b} - {t}_{a} )}^{2}} & \frac{4 {Q}_{c}^{- 1}}{( {t}_{b} - {t}_{a} )}\end{matrix} ] \qquad ( 8 )$$

Prior state mean [symbol] and covariance [symbol] at said synchronized timestamp list ^{iv} [symbol] are calculated similarly.

### 2.1.4. Calculation of Posterior States at Observation

A posterior state mean \hat{μ} at said infrastructure-side timestamp list ⁱ [symbol] is calculated based on an observation y from said trajectory data rₙ and corresponding prior μ̌, Σ̌.

$$\hat{μ} = {( {\check{Σ}}^{- 1} + {C}^{T} {R}^{- 1} C )}^{- 1} ( {\check{Σ}}^{- 1} \check{μ} + {C}^{T} {R}^{- 1} y ) \qquad ( 9 )$$

### 2.1.5. Calculation of Posterior States at Interpolation

A posterior state mean [symbol] at said synchronized timestamp list ^{iv} [symbol] is calculated based on said infrastructure-side timestamp list ⁱ [symbol] , said synchronized timestamp list ^{iv} [symbol] , priors μ̌, Σ̌, [symbol] and [symbol] .

For each timestamp τ in said synchronized timestamp list ^{iv} [symbol] , a posterior mean \hat{μ}(τ) is calculated based on state prior μ̌ₗ, μ̌ₗ₊₁ and posterior \hat{μ}ₗ, \hat{μ}ₗ₊₁ at neighboring timestamp tₗ, tₗ₊₁ and state prior \hat{μ}(τ) at interpolated timestamp τ.

$$\{ \begin{matrix}\hat{μ} ( τ ) = \check{μ} ( τ ) + \begin{matrix}[ Λ ( τ ) & Ψ ( τ ) ] ( [ \begin{matrix}{\hat{μ}}_{l} \\ {\hat{μ}}_{l + 1}\end{matrix} ] - [ \begin{matrix}{\check{μ}}_{l} \\ {\check{μ}}_{l + 1}\end{matrix} ] )\end{matrix} \\ Λ ( τ ) = Φ ( τ , {t}_{l} ) - Ψ ( τ ) Φ ( {t}_{l + 1} , {t}_{l} ) \\ Ψ ( τ ) = {Q}_{l , τ} Φ ( {t}_{l + 1} , τ ) {Q}_{l , l + 1}^{- 1}\end{matrix} \qquad ( 10 )$$

\hat{μ}(τ) is a simple linear combination of the state prior \hat{μ}ₗ₊₁ and posterior \hat{μ}ₗ, \hat{μ}ₗ₊₁ at its neighboring observation timestamps tₗ, tₗ₊₁.

Said synchronized infrastructure-side perception data ^{iv} [symbol] is obtained by organizing said posterior \hat{μ} [symbol] for each trajectory data In.

### 2.2. Trajectory Feature Graph Calculation

An infrastructure-side trajectory feature graph ⁱ [symbol] is calculated based on said synchronized infrastructure-side perception data ^{iv} [symbol] . A vehicle-side trajectory feature graph ^{v} [symbol] is calculated based on vehicle-side positioning data ^{v}S and vehicle-side perception data ^{v} [symbol] .

A trajectory feature graph is defined as [symbol] ={ [symbol] , W¹, W²}. [symbol] is a trajectory identity set with M trajectories. [symbol] is a timestamp list with L frames. The lth frame is marked as timestamp tₗ.

$$𝒱 = \{ 1 , 2 , … , M \} ; 𝒯 = \{ {t}_{1} , {t}_{2} , … {t}_{L} \} \qquad ( 11 )$$

$${W}_{L \times M}^{1}$$

is a first-order feature matrix, representing node features in a graph.

$${W}_{L \times M \times M}^{2}$$

order feature matrix, representing edge features in a graph.

$${W}_{l , q}^{1} = \frac{‖ {v}_{q} ( {t}_{l} ) ‖}{{σ}_{v}} \qquad ( 12 )$$

$${W}_{l , q , j}^{2} = \{ \begin{matrix}0 , & q = j \\ [ \begin{matrix}\frac{‖ {v}_{q} ( {t}_{l} ) - {v}_{j} ( {t}_{l} ) ‖}{{σ}_{v}} \\ \frac{‖ {p}_{q} ( {t}_{l} ) - {p}_{j} ( {t}_{l} ) ‖}{{σ}_{d}}\end{matrix} ] , & q \neq j\end{matrix} \qquad ( 13 )$$

v_{q}(τ) and p_{q}(τ) are velocity and position vector of trajectory q at timestamp t. ∥⋅∥ represents second order norm calculation. σᵥ and σ_{d} are velocity and distance normalization factor. Based on the above calculation, a trajectory feature graph is constructed, providing a basis for vehicle-infrastructure trajectory data matching.

### 2.3. Graph Matching Affinity Matrix Calculation

A vehicle-infrastructure trajectory matching affinity matrix A* is calculated based on said infrastructure-side trajectory feature graph ⁱ [symbol] and said vehicle-side trajectory feature graph ^{v} [symbol] .

### 2.3.1. Affinity Matrix Calculation

Given a vehicle-side trajectory feature graph ^{v} [symbol] ={^{v} [symbol] , ^{v} [symbol] , ^{v}W¹, ^{v}W²} and an infrastructure-side trajectory feature graph ⁱ [symbol] ={^{iv} [symbol] , ^{iv} [symbol] , ⁱW¹, ⁱW²}, a second-order identity correspondence between ^{v} [symbol] and ⁱ [symbol] is marked as (q₁, q₂; j₁, j₂), representing vehicle-side trajectory q₁ and j₁ being matched with infrastructure-side trajectory q₂ and j₂. All potential matchings form a set [symbol] .

$$𝒞 = \{ ( {q}_{1} , {q}_{2} ; {j}_{1} , {j}_{2} ) \vert {q}_{1} , {j}_{1} ∈ {}^{v} 𝒱 ; {q}_{2} , {j}_{2} ∈ {}^{i} 𝒱 \} \qquad ( 14 )$$

In case of missed detections, a pseudo trajectory id set ⁱ [symbol] * is added to ⁱ [symbol] as substitute matches for ⁱ [symbol] . Vehicle-side, infrastructure-side and pseudo trajectory id sets are defined as follows.

$${}^{v} 𝒱 = \{ 1 , 2 , … , M \} \qquad ( 15 )$$

$${}^{i} 𝒱 = \{ 1 , 2 , … , N \} \qquad ( 16 )$$

$${}^{i} {𝒱}^{★} = \{ N + 1 , N + 2 , … , N + M \} \qquad ( 17 )$$

M is the size of vehicle-side trajectory id set. N is the size of infrastructure-side trajectory id set. All potential substitute matchings form a set C*, including three subsets: matchings with starting node missing [symbol] ₁, matchings with ending node missing [symbol] ₂* and matchings with both nodes missing [symbol] ₃*.

$${𝒞}_{1}^{★} = \{ ( {q}_{1} , {q}_{2} ; {i}_{1} , {j}_{2} ) \vert {q}_{1} , {j}_{1} ∈ {}^{v} 𝒱 ; {q}_{2} = {u}_{1} + N , {j}_{2} ∈ {}^{i} 𝒱 \} \qquad ( 18 )$$

$${𝒞}_{2}^{★} = \{ ( {q}_{1} , {q}_{2} ; {j}_{1} , {j}_{2} ) \vert {q}_{1} , {j}_{1} ∈ {}^{v} 𝒱 ; {q}_{2} ∈ {}^{i} 𝒱 , {j}_{2} = {j}_{1} + N \} \qquad ( 19 )$$

$${𝒞}_{3}^{★} = \{ ( {q}_{1} , {q}_{2} ; {j}_{1} , {j}_{2} ) \vert {q}_{1} , {j}_{1} ∈ {}^{v} 𝒱 ; {q}_{2} = {q}_{1} + N , {j}_{2} = {j}_{1} + N \} \qquad ( 20 )$$

$${𝒞}^{★} = {𝒞}_{1}^{★} + {𝒞}_{2}^{★} + {𝒞}_{3}^{★} \qquad ( 21 )$$

Leveraging Gaussian kernel function to evaluate the first and second-order feature similarity, an unnormalized vehicle-infrastructure trajectory matching affinity matrix A is calculated as follows.

$${A}_{l , {q}_{1} {q}_{2} , {j}_{1} {j}_{2}} = \{ \begin{matrix}exp ( - ‖ {}_{}^{v} {W}_{l , {q}_{1}}^{1} - {}_{}^{i} {W}_{l , {q}_{1}}^{1} ‖ ) , & \begin{matrix}( {q}_{1} , {q}_{2} ; {j}_{1} , {j}_{2} ) ∈ 𝒞 , \\ {q}_{1} = {j}_{1} , {q}_{2} = {j}_{2} ,\end{matrix} \\ exp ( - {h}_{1} ) , & \begin{matrix}( {q}_{1} , {q}_{2} ; {j}_{1} , {j}_{2} ) ∈ {𝒞}^{*} , \\ {q}_{1} = {j}_{1} , {q}_{2} = {j}_{2} ,\end{matrix} \\ exp ( - ‖ {}_{}^{v} {W}_{l , {q}_{1} , {j}_{1}}^{2} - {}_{}^{i} {W}_{l , {q}_{2} , {j}_{2}}^{2} ‖ ) , & \begin{matrix}( {q}_{1} , {q}_{2} ; {j}_{1} , {j}_{2} ) ∈ 𝒞 , \\ {q}_{1} \neq {j}_{1} , {q}_{2} \neq {j}_{2} , \\ {}_{}^{v} {W}_{l , {q}_{1} , {j}_{1}}^{2} \neq 0 , {}_{}^{i} {W}_{l , {q}_{2} , {j}_{2}}^{2} \neq 0\end{matrix} \\ exp ( - {h}_{2} ) , & \begin{matrix}( {q}_{1} , {q}_{2} ; {j}_{1} , {j}_{2} ) ∈ {𝒞}^{*} , \\ {q}_{1} \neq {j}_{1} , {q}_{2} \neq {j}_{2} , \\ {}_{}^{v} {W}_{k , {q}_{1} , {j}_{1}}^{2} \neq 0 , {}_{}^{i} {W}_{k , {q}_{2} , {j}_{2}}^{2} \neq 0\end{matrix} \\ 0 , & otherwise\end{matrix} \qquad ( 22 )$$

h₁ is the first-order feature deviation threshold. h₂ is the second-order feature deviation threshold.

### 2.3.2. Affinity Matrix Normalization

Said unnormalized vehicle-infrastructure trajectory matching affinity matrix is normalized through the following process. It is first averaged in the dimension of time, obtaining a time-averaged vehicle-infrastructure trajectory matching affinity matrix.

$${A}_{{q}_{1} {q}_{2} , {j}_{1} {j}_{2}}^{′} = {\sum }_{l = 1}^{\vert {}^{v} 𝒯 \vert} \frac{{A}_{l , {q}_{1} {q}_{2} , {j}_{1} {j}_{2}}}{\vert {d}_{{q}_{1}} ∩ {d}_{{j}_{1}} ∩ {d}_{{q}_{2}} ∩ {d}_{{j}_{2}} \vert} \qquad ( 23 )$$

Then, the first and second-order feature similarity are normalized, obtaining said vehicle-infrastructure trajectory matching affinity matrix.

$${A}_{{q}_{1} {q}_{2} , {j}_{1} {j}_{2}}^{★} = \{ \begin{matrix}\frac{{A}_{{q}_{1} {q}_{2} , {j}_{1} {j}_{2}}^{′}}{M} {α}_{1} , & {q}_{1} = {j}_{1} , {q}_{2} = {j}_{2} \\ \frac{{A}_{{q}_{1} {q}_{2} , {j}_{1} {j}_{2}}^{′}}{\vert {ℰ}^{a} \vert} {α}_{2} , & {q}_{1} \neq {j}_{1} , {q}_{2} \neq {j}_{2}\end{matrix} \qquad ( 24 )$$

α₁, α₂ are weights for first and second-order feature. | [symbol] ^{a}| is the number of second-order feature, which is M(M−1) under a fully connected assumption.

### 2.4. Vehicle-Infrastructure Data Registration and Delay Estimation

A vehicle-infrastructure trajectory matching vector x and said vehicle-infrastructure data delay are calculated based on said vehicle-infrastructure trajectory matching affinity matrix A*, said infrastructure-side perception data ⁱ [symbol] , said vehicle-side positioning data ^{v}S and vehicle-side trajectory feature graph ^{v} [symbol] .

### 2.4.1. Vehicle-Infrastructure Data Registration

Based on said vehicle-infrastructure trajectory matching affinity matrix A*, said vehicle-infrastructure trajectory matching vector x is obtained through a graduated non-convex concave procedure.

An optimization model is built based on said vehicle-infrastructure trajectory matching affinity matrix A*.

$${x}^{⋆} = {argmax}_{x} F ( x ) \qquad ( 25 )$$

$$F ( x ) = {x}^{T} {A}^{⋆} x , s . t . x ∈ \prod , {t}_{d} ∈ ℝ \qquad ( 26 )$$

$$\prod = \{ x \vert {x}_{ij} = \{ 0 , 1 \} ; {\sum }_{j = 1}^{{N}^{′}} {x}_{ij} = 1 , i = 1 , 2 , … M ; {\sum }_{i = 1}^{M} {x}_{ij} \leq 1 , j = 1 , 2 , … {N}^{′} \} \qquad ( 27 )$$

The decision variable x is a binary vector representing vehicle-infrastructure trajectory data correspondence. M is the size of vehicle-side trajectory id set. N′ is the sum size of infrastructure-side and vehicle-side trajectory id set, N′=M+N. A* is the vehicle-infrastructure trajectory matching affinity matrix.

Said vehicle-infrastructure trajectory matching vector is calculated, leveraging a graduated non-convex concave procedure. The process is detailed as follows where ← assigns the value on the right to the variable on the left.
(1) A graduation factor ξ is initialized. Said vehicle-infrastructure trajectory matching vector x is initialized. A step length for graduation factor Dξ is set.
(2) An iteration counter c₂ is initialized. An iteration limit m₂ is set.
(3) Step direction calculation: A step direction h is calculated based on said vehicle-infrastructure trajectory matching affinity matrix A*, graduation factor ξ and vehicle-infrastructure trajectory matching vector x. A Hungarian algorithm is applied to solve for said step direction.

$$h ← {argmax}_{h} ∇ {{F}_{ξ} ( x )}^{T} h , s . t . h ∈ \prod \qquad ( 28 )$$

$$∇ {F}_{ξ} ( x ) = \{ \begin{matrix}( 1 - ξ ) ( A + {A}^{T} ) x + 2 ξ x , & 0 \leq ξ \leq 1 \\ ( 1 + ξ ) ( A + {A}^{T} ) x + 2 ξ x , & - 1 \leq ξ < 0\end{matrix} \qquad ( 29 )$$

(4) Learning rate optimization: A learning rate γ is calculated using a line search algorithm based on said step direction h, said vehicle-infrastructure trajectory matching affinity matrix A*, said graduation factor ξ and vehicle-infrastructure trajectory matching vector x.

$$γ ← {argmax}_{γ} {F}_{ξ} ( x + γ ( h - x ) ) , s . t \text{.0} \leq γ \leq 1 \qquad ( 30 )$$

$${F}_{ξ} ( x ) = \{ \begin{matrix}( 1 - ξ ) F ( x , {t}_{d} ) + ξ {x}^{T} x , & 0 \leq ξ \leq 1 \\ ( 1 + ξ ) F ( x , {t}_{d} ) + ξ {x}^{T} x , & - 1 \leq ξ < 0\end{matrix} \qquad ( 31 )$$

(5) Matching vector update: Said vehicle-infrastructure trajectory matching vector x is updated using said step direction h and learning rate γ, x←x+y (h−x).
(6) A graduated matching similarity measure F_{ξ}(x) is calculated based on said vehicle-infrastructure trajectory matching affinity matrix A*, said vehicle-infrastructure trajectory matching vector x and said graduation factor ξ.
(7) Said iteration counter c₂ is incremented by one, c₂+c₂+1.
(8) If said graduated matching similarity measure F_{ξ}(x) converges or said iteration counter c₂>m₂, sub-step (9) is executed; otherwise, sub-steps (3)˜(7) are repeated.
(9) Said graduation factor ξ is incremented by said step length for graduation factor dξ;
(10) If ξ<1Λx∉Π, sub-steps (3)˜(9) are repeated where II denotes the binary vector set; otherwise, vehicle-infrastructure trajectory matching vector x is finalized.

### 2.4.2. Vehicle-Infrastructure Data Delay Estimation

Said vehicle-infrastructure data delay t_{d} is calculated based on said vehicle-infrastructure trajectory matching vector x, said infrastructure-side perception data ⁱ [symbol] , said vehicle-side positioning data ^{v}S and vehicle-side trajectory feature graph ^{v} [symbol] . The process is detailed as follows.
(1) An upper and lower bound for vehicle-infrastructure delay c, d is initialized for vehicle-infrastructure data delay; a last query position f is initialized; an iteration limit m₄ is set;
(2) A vehicle-infrastructure trajectory matching confidence calculation function G(x, t_{d}) is defined as follows:

An infrastructure-side trajectory feature graph ⁱ [symbol] is calculated through continuous trajectory representation and trajectory feature graph calculation based on said infrastructure-side perception data ⁱ [symbol] , vehicle-infrastructure data delay t_{d}, vehicle-side positioning data ^{v}S.

A delay-compensated vehicle-infrastructure trajectory matching affinity matrix A*(t_{d}) is calculated based on said vehicle-infrastructure trajectory matching vector x.

Said vehicle-infrastructure trajectory matching confidence G(x, t_{d}) is calculated based on said delay-compensated vehicle-infrastructure trajectory matching affinity matrix A*(t_{d}) and vehicle-infrastructure trajectory matching vector x.

$$G ( x , {t}_{d} ) = {x}^{T} {A}^{⋆} ( {t}_{d} ) x \qquad ( 32 )$$

(3) A second and third optimal value g_{c}, g_{d} and a last query value g_{f} are obtained based on said vehicle-infrastructure trajectory matching vector x, vehicle-side trajectory feature graph ^{v} [symbol] , infrastructure-side trajectory perception data ⁱ [symbol] , vehicle-side positioning data ^{v}S, upper and lower bound for vehicle-infrastructure delay c, d and last query position f;

$${g}_{c} = G ( x , c ) , {g}_{d} = G ( x , d ) , {g}_{f} = G ( x , f ) \qquad ( 33 )$$

(4) A vehicle-infrastructure trajectory matching confidence g* is calculated based on vehicle-infrastructure data delay t_{d}, and vehicle-infrastructure trajectory matching vector x through said vehicle-infrastructure trajectory matching confidence calculation function G(x, t_{d});

$${g}^{⋆} = G ( x , {t}_{d} ) \qquad ( 34 )$$

(5) If g* converges or c₄>m₄, output vehicle-infrastructure data delay t_{d} and exit sub-routine; otherwise, go to sub-step (6);
(6) Parameter f, gf, c, d, g_{c}, g_{d} is updated by sorting the order of g_{c}, g_{d}, g_{f}, g*;

$$c < f < d , {g}_{c} \leq {g}_{f} \leq {g}_{d} \qquad ( 35 )$$

(7) If f, g_{f}, c, d, g_{c}, g_{d} constitutes the condition for parabolic interpolation,

$$( f \neq c ) \hat{} ( c \neq d ) \hat{} ( f \neq d ) \hat{} [ \frac{{g}_{f} - {g}_{c}}{{t}_{d} - c} \neq \frac{{g}_{f} - {g}_{d}}{{t}_{d} - d} ] \qquad ( 36 )$$

said vehicle-infrastructure data delay t_{d} is updated using parabolic interpolation based on f, g_{f}, c, d, g_{c}, g_{d};

$${t}_{d} ← \frac{1}{2} \frac{( {f}^{2} - {d}^{2} ) {g}_{c} + ( {d}^{2} - {c}^{2} ) {g}_{f} + ( {c}^{2} - {f}^{2} ) {g}_{d}}{( f - d ) {g}_{c} + ( d - c ) {g}_{f} + ( c - f ) {g}_{d}} \qquad ( 37 )$$

otherwise, said vehicle-infrastructure data delay t_{d} is updated using a golden section method;

$${t}_{d} ← \{ \begin{matrix}\frac{\sqrt{5} - 1}{2} f + \frac{3 - \sqrt{5}}{2} c , & f \geq \frac{c + d}{2} \\ \frac{\sqrt{5} - 1}{2} f + \frac{3 - \sqrt{5}}{2} d , & f < \frac{c + d}{2}\end{matrix} \qquad ( 38 )$$

(8) Said iteration counter c₄ is incremented by one; go to sub-step (4).

When a vehicle-infrastructure data registration and delay estimation is performed, said iteration counter c₁ is incremented by one. If said vehicle-infrastructure trajectory matching vector x converges or said iteration counter c₁>m₁, said vehicle-infrastructure trajectory matching vector x and vehicle-infrastructure data delay t_{d} is finalized; otherwise, repeat step 2.1˜2.4.

### 2.5. Infrastructure-Side Positioning Data Output

Said infrastructure-side positioning data ⁱS is obtained from said vehicle-infrastructure trajectory matching vector x and said infrastructure-side perception data ⁱ [symbol] .

### 3. Calibration Parameter Calculation

A calibration parameter X is calculated from said vehicle-side positioning data ^{v}S and infrastructure-side positioning data ⁱS, involving the following steps: calibration dataset initialization, calibration parameter initialization, calibration error calculation and calibration parameter update.

### 3.1. Calibration Dataset Initialization

Said map coordinate system \vec{F}_{M} is identified as a source coordinate system, being marked as r. Said infrastructure coordinate system \vec{F}_{R} is identified as a target coordinate system, being marked as f. A vehicle-side trajectory ^{r}p is extracted from vehicle-side positioning data ^{v}S. An infrastructure-side trajectory fₚ is extracted from infrastructure-side positioning data ⁱS, forming calibration dataset

$$D = \{ {\{}^{f} t , {}^{f} p , {}^{r} p \} \} .$$

### 3.2. Calibration Parameter Initialization

Said calibration parameter is the spatial and temporal relationship between said map coordinate system \vec{F}_{M} and infrastructure coordinate system \vec{F}_{R}.

$$X = \{ θ , Δ x , Δ y , {t}_{d} \} ∈ {ℝ}^{4} \qquad ( 32 )$$

θ is a rotation angle. Δx, Δy are translations. t_{d} is a clock shift.

Leveraging said continuous trajectory representation, a synchronized vehicle-side trajectory data ⁱp(X) is obtained by interpolation on vehicle-side trajectory data ^{f}p at infrastructure-side timestamp ^{f}t. The correspondence between vehicle-side trajectory data and infrastructure-side trajectory data is established as shown in FIG. 6.

$${i}^{} {p}_{l} ( X ) = {}^{r} p {(}^{f} {t}_{l} - {t}_{d} ) \qquad ( 33 )$$

Said vehicle-infrastructure data delay t_{d} is used as the initial clock shift t_{d}_{₀}. Optionally, if vehicle-infrastructure data delay is unavailable, the initial clock shift is determined by aligning the center of the timestamps.

$${t}_{{d}_{0}} = \frac{1}{M} {\sum }_{l = 1}^{M} {}^{f} {t}_{l} - \frac{1}{N} {\sum }_{l = 1}^{N} {}^{r} {t}_{l} \qquad ( 34 )$$

A singular value decomposition method is applied to solve for the initial rotation matrix R₀ and the initial translation vector t₀.

$${}^{f} {p}_{c} = \frac{1}{M} {\sum }_{l = 1}^{M} {}^{f} {p}_{l} , {}^{i} {p}_{c} = \frac{1}{M} {\sum }_{l = 1}^{M} {}^{i} {p}_{l} \qquad ( 35 )$$

$$W = {\sum }_{l = 1}^{M} ( {}^{f} {p}_{l} - {}^{f} {p}_{c} ) {( {}^{i} {p}_{l} - {}^{i} {p}_{c} )}^{T} , W = U Λ {V}^{T} \qquad ( 36 )$$

$${R}_{0} = {VU}^{T} \qquad ( 37 )$$

$${t}_{0} = \frac{1}{M} {\sum }_{l = 1}^{M} ( {}^{f} {p}_{l} - {R}_{0} {}^{i} {p}_{l} ) \qquad ( 38 )$$

### 3.3. Calibration Error Calculation

A projection of said vehicle-side trajectory data ^{t}pₗ(X) is calculated based on said calibration parameter X.

$${}^{t} {p}_{l} ( X ) = R \cdot {}^{i} {p}_{l} ( X ) + t \qquad ( 39 )$$

$$R = [ \begin{matrix}cos θ & - sin θ \\ sin θ & cos θ\end{matrix} ] , t = [ \begin{matrix}Δ x \\ Δ y\end{matrix} ] \qquad ( 40 )$$

Said calibration error e is determined by calculating the mean distance between said projection of vehicle-side trajectory data ^{t}pₗ(X) and infrastructure-side trajectory data ^{f}pₗ.

$$e ( X ) = {\sum }_{l = 1}^{N} {e}_{l}^{T} {e}_{l} \qquad ( 41 )$$

$${e}_{l} ( X ) = {}^{t} {p}_{l} ( X ) - {}^{f} {p}_{l} \qquad ( 42 )$$

### 3.4. Calibration Parameter Update

Said calibration parameter X is updated via Gauss-Newton based on said calibration dataset D and said calibration error e.

A Jacobian matrix J is calculated based on infrastructure-side trajectory data fₚ and vehicle-side trajectory data ^{r}p, calibration error e and calibration parameter X.

$${e}_{l} ( X + Δ X ) \approx {J}_{l} Δ X + {e}_{l} ( X ) \qquad ( 43 )$$

$${J}_{l} = [ \begin{matrix}\frac{\partial {e}_{l}}{\partial θ} & \frac{\partial {e}_{l}}{\partial ( Δ x )} & \frac{\partial {e}_{l}}{\partial ( Δ y )} & \frac{\partial {e}_{l}}{\partial {t}_{d}}\end{matrix} ] = [ \begin{matrix}{e}_{{y}_{l}} & 1 & 0 & - {}^{i} {v}_{{x}_{l}} ( {}^{i} {t}_{l} ) \\ - {e}_{{x}_{l}} & 0 & 1 & - {}^{i} {v}_{{y}_{l}} ( {}^{i} {t}_{l} )\end{matrix} ] \qquad ( 44 )$$

Jₗ is a Jacobian matrix for eₗ. eₓ_{ₗ}, e_{y}_{ₗ} are components of et in x, y direction.

$${}^{i} {v}_{{x}_{l}} , {}^{i} {v}_{{y}_{l}}$$

are components of vehicle velocity in x, y direction, obtained through said continuous trajectory representation using infrastructure-side trajectory data fₚ and vehicle-side trajectory data ^{r}p.

An update step ΔX is calculated based on said Jacobian matrix J and calibration error e.

$$H = {\sum }_{l = 1}^{M} {J}_{l}^{T} {J}_{l} , b = {\sum }_{l = 1}^{M} {J}_{l}^{T} {e}_{l} ( X ) \qquad ( 45 )$$

$$Δ X = {H}^{- 1} b \qquad ( 46 )$$

Said calibration parameter X is incremented by said update step ΔX, X←X+ΔX.

When a calibration parameter update is performed, said iteration counter c₂ is incremented by one. If said calibration error e converges or said iteration counter c₂>m₂, said calibration parameter X is finalized; otherwise, repeat step 3.3˜3.4.

The invention presents a device and system for rapid multi-sensor calibration of cooperative vehicle-infrastructure systems. FIG. 6 is a schematic diagram of said device and system, involving a vehicle-side module, an infrastructure-side module and a calibration platform.

### 4. Vehicle-Side Module

Onboard positioning devices, onboard perception devices and onboard communication devices are installed on said connected vehicles. Said onboard positioning devices collect vehicle-side positioning data. Said onboard perception devices collect infrastructure-side perception data. Said onboard communication devices manages communications between said vehicle-side module and an infrastructure-side module.
(1) Onboard positioning devices, including GNSS/IMU positioning devices, are installed on said connected vehicles, collecting vehicle-side positioning data.
(2) Onboard perception devices, including radar, lidar and camera, are installed on said connected vehicles, collecting vehicle-side perception data.
(3) Onboard communication devices send data to roadside communication devices.

### 5. Infrastructure-Side Module

Said infrastructure-side module involves roadside perception devices, roadside computation devices, roadside storage devices and roadside communication devices. Said roadside perception devices collect said infrastructure-side perception data. Said roadside communication devices manages communication between said infrastructure-side module and said vehicle-side module.
(1) Roadside perception devices, including radar, lidar and camera, collect raw perception data.
(2) Roadside computation devices, processing said raw perception data, obtaining said infrastructure-side perception data.
(3) Roadside communication devices send data to onboard communication devices.

### 6. Calibration Platform

A calibration platform is deployed on said roadside computation devices, processing data collected by vehicle-side module and infrastructure-side module, calibrating said roadside perception devices.

Said method, device and system for rapid multi-sensor calibration of cooperative vehicle-infrastructure systems provided by the present invention have the following technical key points and advantages:
(1) The method provided by the invention uses vehicle positioning data as a reference for calibrating road domain sensors, allowing for automatic calibration of the spatiotemporal registration parameters of data collected by infrastructure sensors without affecting traffic. This approach saves time and effort, while providing high real-time performance and accuracy. It effectively prevents perception failures due to outdated registration parameters in intelligent vehicle-infrastructure fusion perception, thus reducing safety risks and decision-making errors.
(2) The device requirements for the system provided by the invention are already met by existing intelligent vehicle-infrastructure fusion perception systems, so there is no need to add dedicated calibration-specific perception, computing, or communication equipment. The calibration data required for the registration method is already present in the existing intelligent vehicle-infrastructure fusion perception system, eliminating the need for additional perception or communication tasks.
(3) The method provided by the invention uses weighted feature graphs to represent vehicle and infrastructure-side trajectory data, matching the vehicle perception data with the vehicle-infrastructure trajectory data as a reference. Through graph matching algorithms, it achieves efficient and accurate matching of vehicle-infrastructure trajectory data.
(4) The method provided by the invention uses continuous-time Gaussian process modeling to interpolate infrastructure-side perception data and vehicle positioning data, accurately achieving spatiotemporal synchronization of vehicle-infrastructure data.

### BRIEF DESCRIPTION OF THE DRAWINGS

FIG. 1 is a flowchart of the method for rapid multi-sensor calibration of cooperative vehicle-infrastructure systems.

FIG. 2 is a flowchart of the continuous trajectory representation.

FIG. 3 is a flowchart of the vehicle-infrastructure data registration and delay estimation.

FIG. 4 is a flowchart of the vehicle-infrastructure data registration.

FIG. 5 is a flowchart of the vehicle-infrastructure data delay estimation.

FIG. 6 is a schematic diagram of the device and system for rapid multi-sensor calibration of cooperative vehicle-infrastructure systems.

FIG. 7 is a schematic diagram of the relationship between vehicle and infrastructure-side data.

FIG. 8 is a schematic diagram of the vehicle-infrastructure trajectory data affinity matrix.

FIG. 9 is a sample diagram of calibration data in Embodiment 1.

FIG. 10 is a sample diagram of the Gaussian process regression interpolation results for infrastructure-side perception data in Embodiment 1.

FIG. 11 is a sample diagram of the calibration results of the roadside millimeter-wave radar in Embodiment 1.

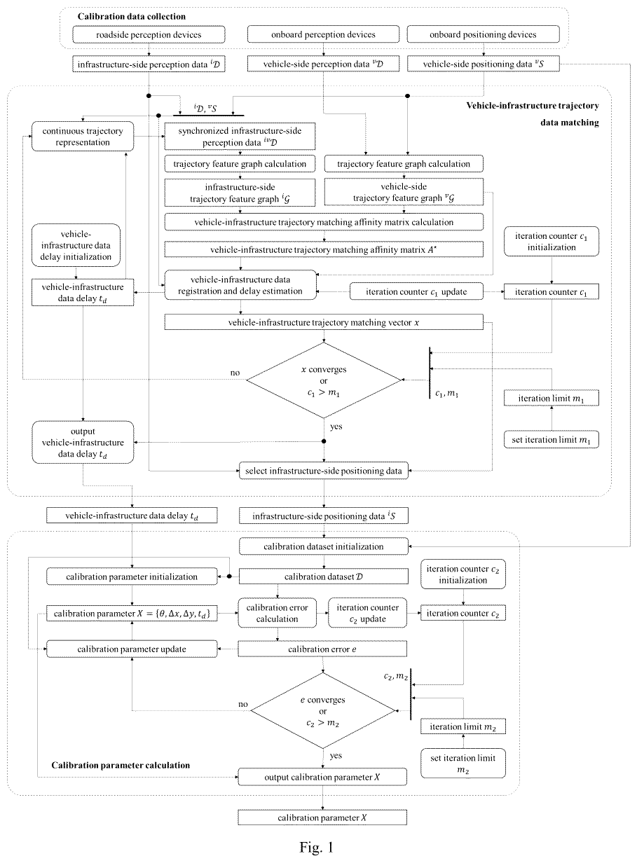

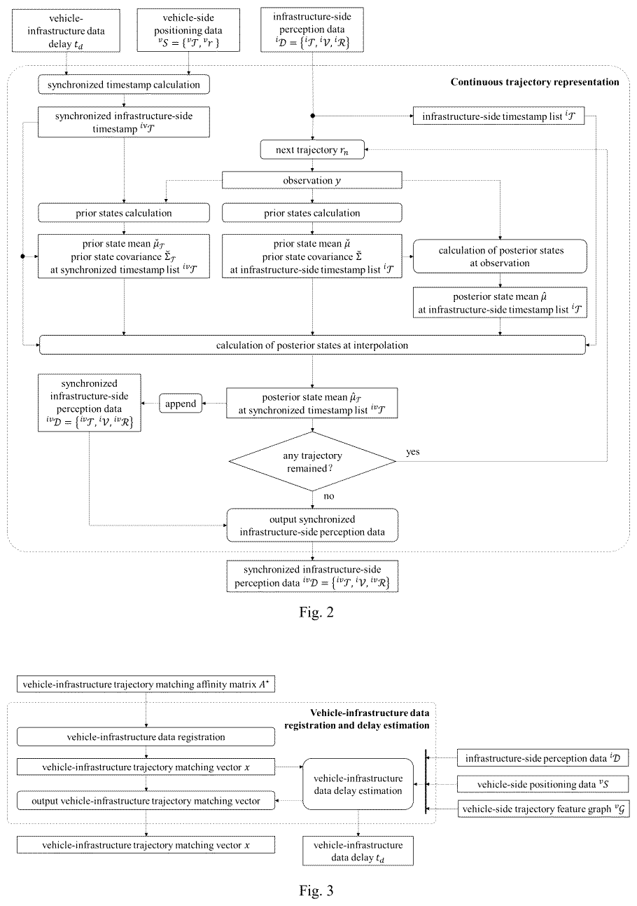

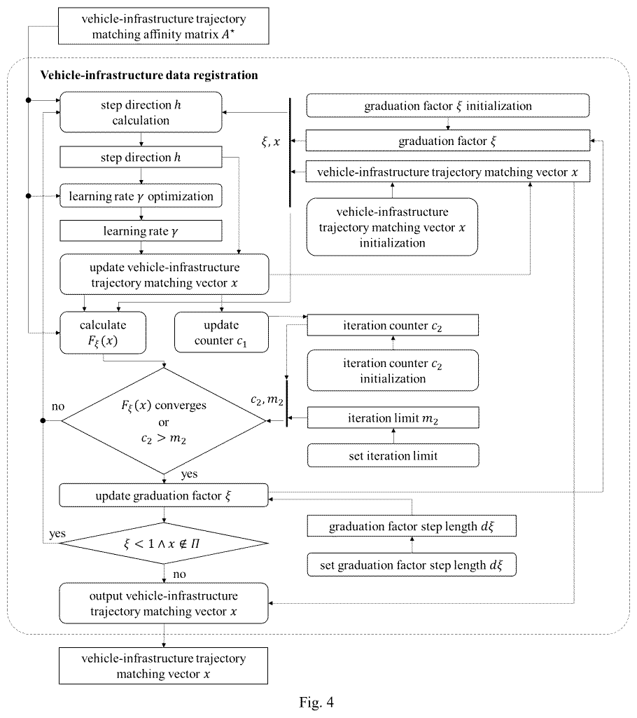

### DETAILED DESCRIPTION OF THE INVENTION

The present invention involves a method, device and system for rapid multi-sensor calibration of cooperative vehicle-infrastructure systems. The following provides a more detailed description of specific embodiments of the present invention in conjunction with the accompanying drawings and specific examples.

### Embodiment 1: Spatiotemporal Synchronization of Millimeter-Wave Radar Data in the Traffic Surveillance System of Donghai Bridge

The multi-sensor system involved includes multiple millimeter-wave radar sensors installed on the roadside of the Donghai Bridge, along with corresponding roadside computing devices and roadside communication devices, forming the infrastructure-side module. The intelligent container truck, acting as a connected vehicle, is integrated with corresponding onboard positioning devices, onboard sensing devices, and onboard communication devices, forming the vehicle-side module. These two modules can transmit data and communicate with the calibration platform for multi-source data, which is deployed on the roadside computing devices, constituting the rapid multi-sensor calibration system proposed in this invention.

In this embodiment, the roadside millimeter-wave radar perception data includes the position and speed of vehicle targets in the radar coordinate system, with a sampling frequency of 10 Hz. The intelligent container truck's positioning and perception data are sampled at a frequency of 25 Hz, which is asynchronous with the roadside millimeter-wave radar in terms of sampling time. These two devices use different positioning coordinate systems. The millimeter-wave radar is a roadside sensor that requires spatiotemporal calibration to determine the spatial transformation parameters and temporal offset parameters between the respective coordinate systems.

Based on the above system, the specific implementation method for rapid multi-sensor calibration of cooperative vehicle-infrastructure systems, includes the following steps.

### Step 1: Calibration Data Collection

This embodiment utilizes intelligent container trucks, where the vehicles collect calibration data within the millimeter-wave radar sensing coverage area on the Donghai Bridge. Specifically, the vehicle-side module collects the vehicle-side positioning and perception data. Infrastructure-side module collects multi-target trajectory data from the millimeter-wave radar during the corresponding period. The onboard positioning equipment uses GNSS/IMU integrated positioning devices, capable of outputting the vehicle's latitude and longitude coordinates with centimeter-level positioning accuracy. The onboard sensing equipment is equipped with three LiDARs, six millimeter-wave radars, and two camera sensors, capable of outputting the relative coordinates of surrounding vehicles with a sensing accuracy of millimeter-level precision.

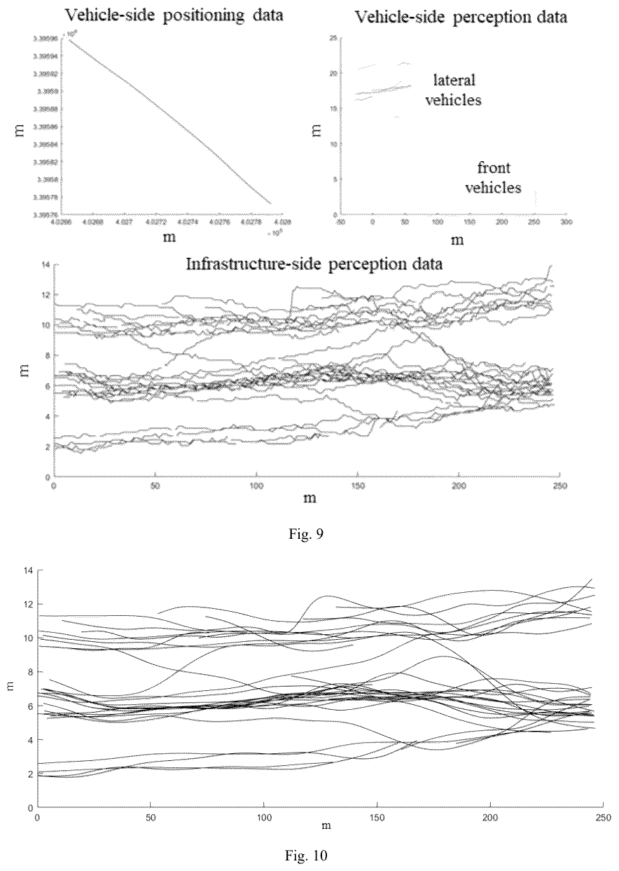

Based on the above data collection process, the calibration data collected is shown in FIG. 9, with the explanation of the corresponding data fields listed in the table below. The vehicle-side positioning data is in the WGS84 coordinate system, the vehicle-side perception data is in the vehicle coordinate system, and the roadside radar data is in a local plane coordinate system. For the collected calibration data, the communication units within the respective modules transmit the data to the calibration platform, where subsequent calibration data processing steps are performed.

| Data Sources | | |
|---|---|---|
| (Coordinate | | |
| system) | Field Name | Description |
| Infrastructure- | Time | Infrastructure-side timestamp, HH:MM:SS:SSS |
| side millimeter- | ID | Infrastructure-side vehicle target identity |
| wave radar | X | Infrastructure-side vehicle target position, x-coordinates, m |
| (Infrastructure | Y | Infrastructure-side vehicle target position, y-coordinates, m |
| coordinate | SpeedX | Infrastructure-side vehicle target velocity, x-direction, m/s |
| system) | SpeedY | Infrastructure-side vehicle target velocity, y-direction, m/s |
| Vehicle-side | std_time | Vehicle-side timestamp, HH:MM:SS:SSS |
| positioning | Longitude | Vehicle longitude positioning, degree |
| devices | Latitude | Vehicle latitude positioning, degree |
| (Map coordinate | Heading | Vehicle heading degree |
| system) | Pitch | Vehicle pitch degree |
| | Roll | Vehicle roll degree |
| | Acceleration | Vehicle acceleration, m/s² |
| Vehicle-side | std_time | Vehicle-side timestamp, HH:MM:SS:SSS |
| perception | nObjectID | Vehicle-side vehicle target identity |
| devices | fRelX | Vehicle-side vehicle target position, x-coordinates, m |
| (Vehicle | fRelY | Vehicle-side vehicle target position, y-coordinates, m |
| coordinate | fAbsVelX | Vehicle-side vehicle target velocity, x-direction, m/s |
| system) | fAbsVelY | Vehicle-side vehicle target velocity, y-direction, m/s |

### Step 2: Continuous Trajectory Representation Modelling

Step 2.1: For each trajectory data, a continuous-time Gaussian process z(τ)˜ [symbol] (μ̌(t), Σ̌ (t, t′)) and a discreate-time observation model yₗ=Cₗzₗ+nₗ are built to estimate the vehicle state. μ̌(t), Σ̌ (t, t′) are prior mean and covariance. zₗ is a state vector at the lth timestamp tₗ. yₗ is a lth observation. Cₗ is an observation matrix. nₗ is an observation noise, following zero-mean Gaussian distribution with covariance matrix Rₗ.

$$z ( t ) = {[ \begin{matrix}p {( t )}^{⊤} & v {( t )}^{⊤}\end{matrix} ]}^{⊤} , \qquad p ( t ) ∈ {ℝ}^{2} , v ( t ) ∈ {ℝ}^{2}$$

$${R}_{l} = 0.1 \cdot {I}_{2} , \qquad {C}_{l} = [ \begin{matrix}{I}_{2} & {0}_{2}\end{matrix} ]$$

Step 2.2: Gaussian process regression is applied to estimate vehicle location and speed. Said Gaussian process is defined as ż(t)=Bz(t)+u(t)+Zw(t). B and Z are system matrices. u is an input signal. w is zero mean Gaussian process, covariance matrix of which is defined by a process noise matrix Q_{c}.

$$u ( t ) = 0 , \qquad w ( t ) ∼ 𝒩 ( 0 , {Q}_{c} )$$

$$B = [ \begin{matrix}{0}_{2} & {I}_{2} \\ {0}_{2} & {0}_{2}\end{matrix} ] , Z = [ \begin{matrix}{0}_{2} \\ {I}_{2}\end{matrix} ] , {Q}_{c} = {I}_{2}$$

Through the Gaussian process regression described above, the vehicle-side positioning trajectory data is represented with a continuous-time model. The resulting vehicle trajectory is shown in FIG. 10.

### Step 3: Trajectory Feature Graph Construction and Affinity Matrix Calculation

Step 3.1: Trajectory feature graph calculation. An infrastructure-side trajectory feature graph ⁱ [symbol] ={ⁱ [symbol] , ^{iv} [symbol] , ⁱW¹, ⁱW²} is calculated based on said synchronized infrastructure-side perception data ^{iv} [symbol] . A vehicle-side trajectory feature graph ^{v} [symbol] ={^{v} [symbol] , ^{v} [symbol] , ^{v}W¹, ^{v}W²} is calculated based on vehicle-side positioning data ^{v}S and vehicle-side perception data ^{v} [symbol] .

[symbol] is a trajectory identity set with M trajectories. [symbol] is a timestamp list with L frames. W_{L×M}¹ is a first-order feature matrix, representing node features in a graph. W_{L×M×M}² is a second-order feature matrix, representing edge features in a graph.

$${W}_{l , q}^{1} = \frac{‖ {v}_{q} ( {t}_{l} ) ‖}{{σ}_{v}}$$

$${W}_{l , q , j}^{2} = \{ \begin{matrix}0 , & q = j \\ [ \begin{matrix}\frac{‖ {v}_{q} ( {t}_{l} ) - {v}_{j} ( {t}_{l} ) ‖}{{σ}_{v}} \\ \frac{‖ {p}_{q} ( {t}_{l} ) - {p}_{j} ( {t}_{l} ) ‖}{{σ}_{d}}\end{matrix} ] , & q \neq j\end{matrix}$$

v_{q}(t) and p_{q}(t) are velocity and position vector of trajectory q at timestamp t. ∥⋅∥ represents second order norm calculation. Oy and Ga are velocity and distance normalization factor.

$${σ}_{v} = 10 ( m / s ) , \qquad {σ}_{d} = 5 ( m )$$

Step 3.2: Vehicle-infrastructure trajectory matching affinity matrix calculation. A second-order identity correspondence between ^{v} [symbol] and ⁱ [symbol] is marked as (q₁, q₂; j₁,j₂), representing vehicle-side trajectory q₁ and j₁ being matched with infrastructure-side trajectory q₂ and j₂. All potential matchings form a set [symbol] ={(q₁, q₂; j₁,j₂)|q₁, j₁∈ⁱ [symbol] ; q₂, j₂∈^{v} [symbol] }. In case of missed detections, a pseudo trajectory id set ⁱ [symbol] * is added to ⁱ [symbol] as substitute matches for V. Leveraging Gaussian kernel function to evaluate the first and second-order feature similarity, a vehicle-infrastructure trajectory matching affinity matrix A is calculated as Equation (22)˜(24).

### Step 4: Vehicle-Infrastructure Trajectory Data Registration

Step 4.1: Optimization model construction. An optimization model is built based on said vehicle-infrastructure trajectory matching affinity matrix A*.

$$x *= {argmax}_{x} F ( x )$$

$$F ( x ) = {x}^{T} A * x , \qquad s . t . x ∈ \prod , {t}_{d} ∈ ℝ$$

$$\prod = \{ x \vert {x}_{ij} = \{ 0 , 1 \} ; {\sum }_{j = 1}^{{N}^{′}} {x}_{ij} = 1 , i = 1 , 2 , … M ; {\sum }_{i = 1}^{M} {x}_{ij} \leq 1 , j = 1 , 2 , … {N}^{′} \}$$

The decision variable x is a binary vector representing vehicle-infrastructure trajectory data correspondence. M is the size of vehicle-side trajectory id set. N′ is the sum size of infrastructure-side and vehicle-side trajectory id set, N′=M+N. A* is the vehicle-infrastructure trajectory matching affinity matrix.
Step 4.2: Optimized matching vector calculation. A graduation factor ξ is initialized. Said vehicle-infrastructure trajectory matching vector x is initialized. A step length for graduation factor dξ is set.

$${t}_{d} = 0 , \qquad ξ = - 1 , \qquad d ξ = 0.01 , \qquad {x}_{0} = {N}^{′} \cdot {1}_{{MN}^{′} \times 1}$$

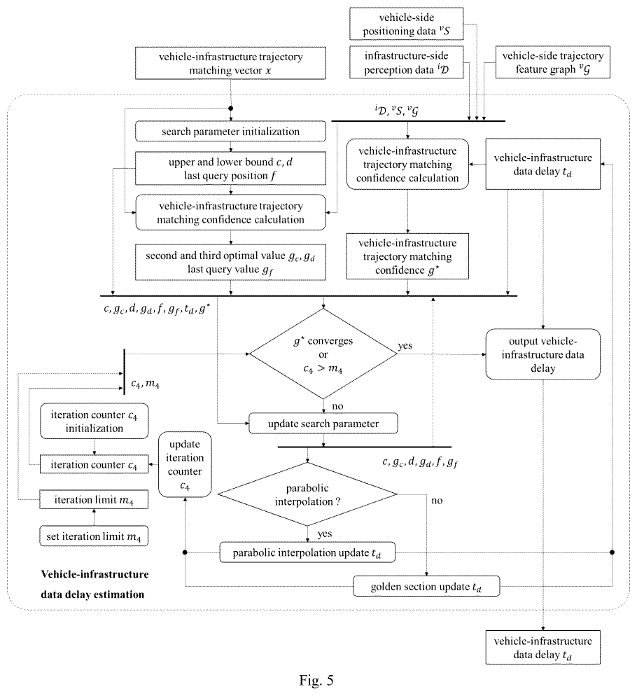

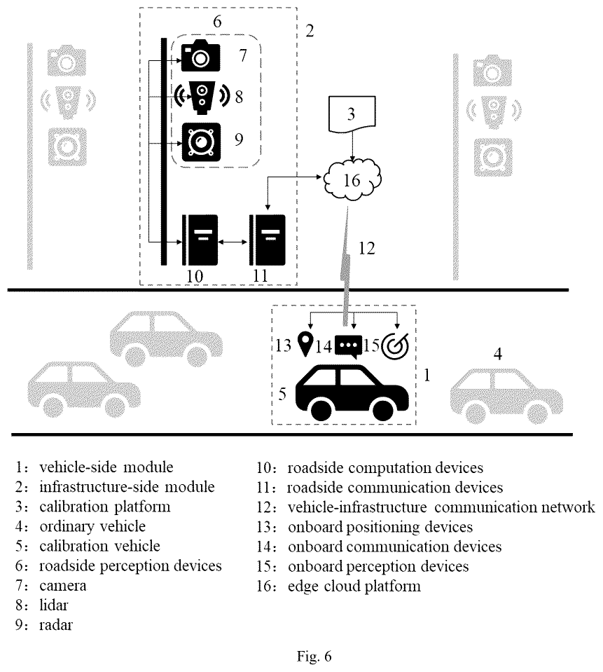

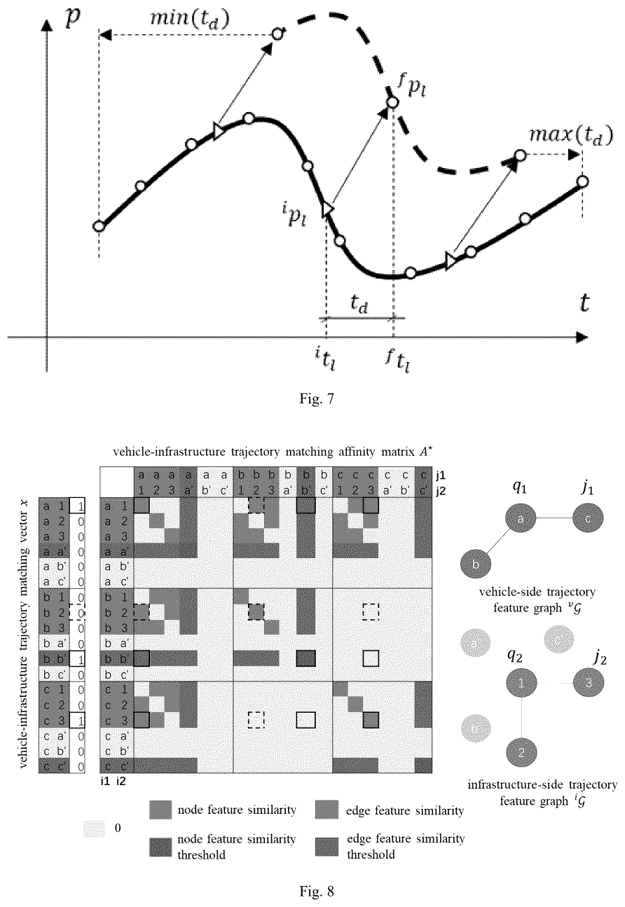

Said vehicle-infrastructure trajectory matching vector x is calculated using a graduated non-convex concave procedure, as shown in FIG. 4.
Step 4.3: Vehicle-infrastructure data delay estimation. An upper and lower bound for vehicle-infrastructure delay c, d is initialized for vehicle-infrastructure data delay, as shown in FIG. 5.

$$c = 300 ( ms ) , \qquad d = - 3 \; 00 ( ms )$$

Step 4.4: Step 4.2˜4.3 is repeated until said vehicle-infrastructure trajectory matching vector x converges or the iteration counter breaks the upper limit m₁.

$${m}_{1} = 5000$$

### Step 5: Calculation of Spatiotemporal Parameters of a Single Millimeter-Wave Radar

A calibration parameter X is calculated from said vehicle-side positioning data ^{v}S and infrastructure-side positioning data ⁱS.
Step 5.1: Continuous representation of vehicle-side trajectory data. Leveraging said continuous trajectory representation, a synchronized vehicle-side trajectory data ⁱp(X) is obtained by interpolation on vehicle-side trajectory data ^{f}p at infrastructure-side timestamp ^{f}t.
Step 5.2: Optimization target calculation: A calibration error e is calculated via said continuous trajectory representation based on said calibration dataset [symbol] and said calibration parameter X={θ, Δx, Δy, t_{d}}∈ [symbol] ⁴.
Step 5.3: Calibration parameter initialization: Said vehicle-infrastructure data delay t_{d} is used as the initial clock shift tan A singular value decomposition method is applied to solve for the initial rotation matrix R₀ and the initial translation vector t₀.
Step 5.4: Calibration parameter update: Said calibration parameter X is updated via Gauss-Newton based on said calibration dataset [symbol] and said calibration error e until error e converges or said iteration counter exceeds the limit m₂.

$${m}_{2} = 3000$$

### Step 6: Calculation of Spatiotemporal Parameters of Multiple Millimeter-Wave Radars

Based on the optimization method for single-sensor calibration parameters in step 5, the positioning data obtained from different roadside millimeter-wave radar sensors can be individually transformed from their local plane coordinate systems into the vehicle positioning coordinate system. This allows for the construction of an optimization model for the spatiotemporal calibration parameters between different sensors. By using the Gauss-Newton iterative method, the optimal spatiotemporal registration parameters between coordinate systems are determined, achieving rapid calibration between multiple roadside millimeter-wave sensors and onboard sensors.

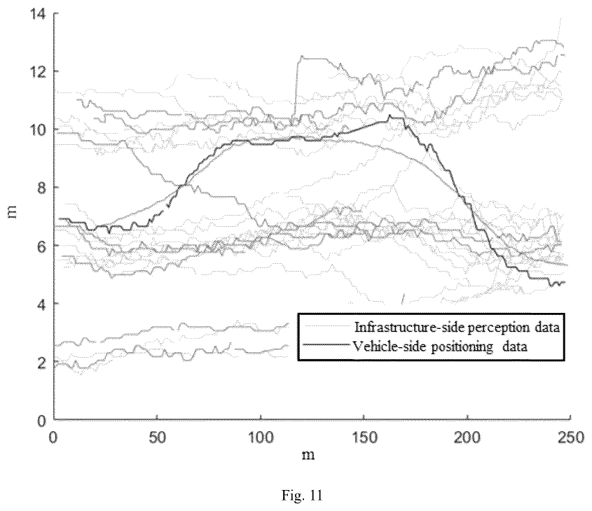

In this embodiment, the calibration results for the selected roadside millimeter-wave radar are shown in FIG. 11. The projection of the vehicle positioning data aligns well with the millimeter-wave radar trajectory data, and the root mean square error of the coordinate calibration is as low as 0.09 m. This level of precision reflects an impressively tight integration, underscoring the effectiveness of the calibration and optimization process in this system.

### Embodiment 2: Spatiotemporal Synchronization of Millimeter-Wave Radar Data in the Traffic Surveillance System of Hangzhou Bay Bridge

The multi-sensor system involved includes multiple millimeter-wave radar sensors installed on the roadside of the Hangzhou Bay Bridge, along with corresponding roadside computing devices and roadside communication devices, forming the infrastructure-side module. The autonomous vehicle is integrated with corresponding onboard positioning devices, onboard sensing devices, and onboard communication devices, forming the vehicle-side module. These two modules can transmit data and communicate with the calibration platform for multi-source data, which is deployed on the roadside computing devices, constituting the rapid multi-sensor calibration system proposed in this invention.

In this embodiment, the roadside millimeter-wave radar perception data includes the position and speed of vehicle targets in the radar coordinate system, with a sampling frequency of 10 Hz. The autonomous vehicles' positioning and perception data are sampled at a frequency of 10 Hz, which is asynchronous with the roadside millimeter-wave radar in terms of sampling time. These two devices use different positioning coordinate systems. The millimeter-wave radar is a roadside sensor that requires spatiotemporal calibration to determine the spatial transformation parameters and temporal offset parameters between the respective coordinate systems.

### Step 1: Calibration Data Collection

In this embodiment, the data collection process and resulting data is the same as Embodiment 1.

### Step 2: Continuous Trajectory Representation Modelling

Step 2.1: For each trajectory data, a continuous-time Gaussian process z(t)˜ [symbol] (μ̌(t), Σ̌(t, t′)) and a discreate-time observation model yₗ=Cₗzₗ+nₗ are built to estimate the vehicle state. μ̌(t), Σ̌(t, t′) are prior mean and covariance. zₗ is a state vector at the lth timestamp tₗ. yₗ is a lth observation. Cₗ is an observation matrix. nₗ is an observation noise, following zero-mean Gaussian distribution with covariance matrix Rₗ.

$$z ( t ) = {[ \begin{matrix}p {( t )}^{⊤} & v {( t )}^{⊤} & a {( t )}^{⊤}\end{matrix} ]}^{⊤} , \qquad p ( t ) ∈ {ℝ}^{2} , v ( t ) ∈ {ℝ}^{2} , a ( t ) ∈ {ℝ}^{2}$$

$${R}_{l} = 0.3 \cdot I , \qquad {C}_{l} = [ \begin{matrix}I & 0 & 0\end{matrix} ]$$

Step 2.2: Gaussian process regression is applied to estimate vehicle location and speed. Said Gaussian process is defined as ż(t)=Bz(t)+u(t)+Zw(t). B and Z are system matrices. u is an input signal. w is zero mean Gaussian process, covariance matrix of which is defined by a process noise matrix Q_{c}.

$$u ( t ) = 0 , w ( t ) ∼ 𝒩 ( 0 , {Q}_{c} ) \\ B = [ \begin{matrix}0 & I & 0 \\ 0 & 0 & I \\ 0 & 0 & 0\end{matrix} ] , Z = [ \begin{matrix}0 \\ 0 \\ I\end{matrix} ] , Qc = 0.5 \cdot I$$

### Step 3: Trajectory Feature Graph Construction and Affinity Matrix Calculation

Step 3.1: Trajectory feature graph calculation. An infrastructure-side trajectory feature graph ⁱ [symbol] ={ⁱ [symbol] , ^{iv} [symbol] , ⁱW¹, ⁱW²} is calculated based on said synchronized infrastructure-side perception data ^{iv} [symbol] . A vehicle-side trajectory feature graph ^{v} [symbol] ={^{v} [symbol] , ^{v} [symbol] , ^{v}W¹, ^{v}W²} is calculated based on vehicle-side positioning data ^{v}Sₖ and vehicle-side perception data ^{v} [symbol] ₖ.

[symbol] is a trajectory identity set with M trajectories. [symbol] is a timestamp list with L frames.

$${W}_{L \times M}^{1}$$

is a first-order feature matrix, representing node features in a graph.

$${W}_{L \times M \times M}^{2}$$

is a second-order feature matrix, representing edge features in a graph.

$${W}_{l , q}^{1} = \frac{‖ {v}_{q} ( {t}_{l} ) ‖}{{σ}_{v}} \\ {W}_{l , q , j}^{2} = \{ \begin{matrix}0 , & q = j \\ [ \begin{matrix}\frac{‖ {v}_{q} ( {t}_{l} ) - {v}_{j} ( {t}_{l} ) ‖}{{σ}_{v}} \\ \frac{‖ {p}_{q} ( {t}_{l} ) - {p}_{j} ( {t}_{l} ) ‖}{{σ}_{d}}\end{matrix} ] , & q \neq j\end{matrix}$$

v_{q}(t) and p_{q}(t) are velocity and position vector of trajectory q at timestamp t. ∥⋅∥ represents second order norm calculation. σᵥ and σ_{d} are velocity and distance normalization factor.

$${σ}_{v} = 5 ( m / s ) , {σ}_{d} = 10 ( m )$$

Step 3.2: Vehicle-infrastructure trajectory matching affinity matrix calculation is the same as Embodiment 1.

### Step 4: Vehicle-Infrastructure Trajectory Data Registration

Step 4.1: Optimization model construction is the same as Embodiment 1.
Step 4.2: Optimized matching vector calculation. A graduation factor ξ is initialized. Said vehicle-infrastructure trajectory matching vector x is initialized. A step length for graduation factor dξ is set.

$${t}_{d} - = 20 ( ms ) , ξ = - 0.8 , d ξ = 0.005 , {x}_{0} = {N}^{′ - 1} \cdot {1}_{{MN}^{′} \times 1}$$

Said vehicle-infrastructure trajectory matching vector x is calculated using a graduated non-convex concave procedure, as shown in FIG. 4.
Step 4.3: Vehicle-infrastructure data delay estimation. An upper and lower bound for vehicle-infrastructure delay c, d is initialized for vehicle-infrastructure data delay, as shown in FIG. 5.

$$c = 5 \; 00 ( ms ) , d = - 5 \; 00 ( ms )$$

Step 4.4: Step 4.2˜4.3 is repeated until said vehicle-infrastructure trajectory matching vector x converges or the iteration counter breaks the upper limit m₁.

$${m}_{1} = 1000$$

### Step 5: Calculation of Spatiotemporal Parameters of a Single Millimeter-Wave Radar

Step 5.1˜5.2 is the same as Embodiment 1.
Step 5.3: Calibration parameter initialization: The initial clock shift is determined by aligning the center of the timestamps. A singular value decomposition method is applied to solve for the initial rotation matrix R₀ and the initial translation vector t₀.
Step 5.4: Calibration parameter update: Said calibration parameter X is updated via Gauss-Newton based on said calibration dataset [symbol] and said calibration error e until error e converges or said iteration counter exceeds the limit m₂.

$${m}_{2} = 1000$$

### Step 6: Calculation of Spatiotemporal Parameters of Multiple Millimeter-Wave Radars

Step 6 is the same as Embodiment 1.

### Embodiment 3: Spatiotemporal Synchronization of Video Data at an Intersection

The multi-sensor system involved includes multiple cameras installed at an intersection, along with corresponding roadside computing devices and roadside communication devices, forming the infrastructure-side module. The autonomous vehicle is integrated with corresponding onboard positioning devices, onboard sensing devices, and onboard communication devices, forming the vehicle-side module. These two modules can transmit data and communicate with the calibration platform for multi-source data, which is deployed on the roadside computing devices, constituting the rapid multi-sensor calibration system proposed in this invention.

In this embodiment, the roadside camera perception data includes the position and speed of vehicle targets in the radar coordinate system, with a sampling frequency of 20 Hz. The autonomous vehicles' positioning and perception data are sampled at a frequency of 10 Hz, which is asynchronous with the roadside millimeter-wave radar in terms of sampling time. These two devices use different positioning coordinate systems. The millimeter-wave radar is a roadside sensor that requires spatiotemporal calibration to determine the spatial transformation parameters and temporal offset parameters between the respective coordinate systems.

### Step 1: Calibration Data Collection

In this embodiment, the data collection process and resulting data is the same as Embodiment 1.

### Step 2: Continuous Trajectory Representation Modelling

Step 2.1˜2.2 are the same as Embodiment 1.

### Step 3: Trajectory Feature Graph Construction and Affinity Matrix Calculation

Step 3.1: Trajectory feature graph calculation. An infrastructure-side trajectory feature graph ⁱ [symbol] ={ⁱ [symbol] , ^{iv} [symbol] , ⁱW¹, ⁱW²} is calculated based on said synchronized infrastructure-side perception data ^{iv} [symbol] . A vehicle-side trajectory feature graph ^{v} [symbol] ={^{v} [symbol] , ^{v} [symbol] , ^{v}W¹, ^{v}W²} is calculated based on vehicle-side positioning data ^{v}Sₖ and vehicle-side perception data ^{v} [symbol] ₖ. [symbol]
   is a trajectory identity set with M trajectories. [symbol] is a timestamp list with L frames. W_{L×M}¹ is a first-order feature matrix, representing node features in a graph. W_{L×M×M}² is a second-order feature matrix, representing edge features in a graph.

$${W}_{l , q}^{1} = \frac{‖ {v}_{q} ( {t}_{l} ) ‖}{{σ}_{v}} \\ {W}_{l , q , j}^{2} = \{ \begin{matrix}0 , & q = j \\ [ \begin{matrix}\frac{‖ {v}_{q} ( {t}_{l} ) - {v}_{j} ( {t}_{l} ) ‖}{{σ}_{v}} \\ \frac{‖ {p}_{q} ( {t}_{l} ) - {p}_{j} ( {t}_{l} ) ‖}{{σ}_{d}}\end{matrix} ] , & q \neq j\end{matrix}$$

v_{q}(t) and p_{q}(t) are velocity and position vector of trajectory q at timestamp t. |⋅| represents second order norm calculation. σᵥ and σ_{d} are velocity and distance normalization factor.

$${σ}_{v} = 10 ( m / s ) , {σ}_{d} = 10 ( m )$$

Step 3.2: Vehicle-infrastructure trajectory matching affinity matrix calculation is the same as Embodiment 1.

### Step 4: Vehicle-Infrastructure Trajectory Data Registration

Step 4.1: Optimization model construction is the same as Embodiment 1.
Step 4.2: Optimized matching vector calculation. A graduation factor ξ is initialized. Said vehicle-infrastructure trajectory matching vector x is initialized. A step length for graduation factor dξ is set.

$${t}_{d} = 10 ( ms ) , ξ = - 1 , d ξ = 0.01 , {x}_{0} = {N}^{′ - 1} \cdot {1}_{{MN}^{′} \times 1}$$

Said vehicle-infrastructure trajectory matching vector x is calculated using a graduated non-convex concave procedure, as shown in FIG. 4.
Step 4.3: Vehicle-infrastructure data delay estimation. An upper and lower bound for vehicle-infrastructure delay c, d is initialized for vehicle-infrastructure data delay, as shown in FIG. 5.

$$c = 3 \; 00 ( ms ) , d = - 3 \; 00 ( ms )$$

Step 4.4: Step 4.2˜4.3 is repeated until said vehicle-infrastructure trajectory matching vector x converges or the iteration counter breaks the upper limit m₁.

$${m}_{1} = 5000$$

### Step 5: Calculation of Spatiotemporal Parameters of a Single Camera

Step 5.1˜5.3 is the same as Embodiment 1.
Step 5.4: Calibration parameter update: Said calibration parameter X is updated via Gauss-Newton based on said calibration dataset [symbol] and said calibration error e until error e converges or said iteration counter exceeds the limit m₂.

$${m}_{2} = 3000$$

### Step 6: Calculation of Spatiotemporal Parameters of Multiple Cameras

Step 6 is the same as Embodiment 1.

1. A method for rapid calibration of multiple sensors in cooperative vehicle-infrastructure systems, comprising the following steps:
1.1) Calibration data collection:
A connected vehicle collects a vehicle-side positioning data ^{v}S and a vehicle-side perception data ^{v} [symbol] ; Roadside perception devices collect an infrastructure-side perception data ⁱ [symbol] ;
1.2) Vehicle-infrastructure trajectory data matching:
An infrastructure-side positioning data ⁱS is obtained from said vehicle-side positioning data ^{v}S, vehicle-side perception data ^{v} [symbol] and said infrastructure-side perception data ⁱ [symbol] ;
1.3) Calibration parameter calculation:
A calibration parameter X is calculated from said vehicle-side positioning data ^{v}S and infrastructure-side positioning data ⁱS.

2. A method according to claim 1, wherein said calibration data collection comprises the following sub-steps:
2.1) One or more connected vehicles equipped with onboard positioning devices and onboard perception devices drive within a field of view of said roadside perception devices;
2.2) Said roadside perception devices collect infrastructure-side perception data ⁱ [symbol] in an infrastructure coordinate system \vec{F}_{R};
2.3) Said onboard positioning devices collect vehicle-side positioning data ^{v}S in a map coordinate system \vec{F}_{M};
2.4) Said onboard perception devices collect vehicle-side perception data ^{v} [symbol] in a vehicle coordinate system \vec{F}_{E}.

3. A method according to claim 1, wherein said vehicle-infrastructure trajectory data matching comprises the following sub-steps:
3.1) A vehicle-infrastructure data delay t_{d} is initialized; an iteration counter c₁ is initialized; an iteration limit m₁ is initialized;
3.2) Continuous trajectory representation:
A synchronized infrastructure-side perception data ^{iv} [symbol] is calculated by running Gaussian process regression on said infrastructure-side perception data ⁱ [symbol] and data querying based on vehicle-side positioning data ^{v}S and said vehicle-infrastructure data delay t_{d};
3.3) Trajectory feature graph calculation:
An infrastructure-side trajectory feature graph ⁱ [symbol] is calculated based on said synchronized infrastructure-side perception data ^{iv} [symbol] ; A vehicle-side trajectory feature graph ^{v} [symbol] is calculated based on vehicle-side positioning data ^{v}S and vehicle-side perception data ^{v} [symbol] ;
3.4) Graph matching affinity matrix calculation:
A vehicle-infrastructure trajectory matching affinity matrix A* is calculated based on said infrastructure-side trajectory feature graph ⁱ [symbol] and said vehicle-side trajectory feature graph ^{v} [symbol] ;
3.5) Vehicle-infrastructure data registration and delay estimation:
A vehicle-infrastructure trajectory matching vector x and said vehicle-infrastructure data delay are calculated based on said vehicle-infrastructure trajectory matching affinity matrix A*, said infrastructure-side perception data ⁱ [symbol] , said vehicle-side positioning data ^{v}S and vehicle-side trajectory feature graph ^{v} [symbol] ;
3.6) Said iteration counter c₁ is incremented by one;
3.7) If said vehicle-infrastructure trajectory matching vector x converges or said iteration counter c₁>m₁, said vehicle-infrastructure trajectory matching vector x and vehicle-infrastructure data delay t_{d} is finalized; otherwise, repeat sub-step 3.2)˜3.6);
3.8) Infrastructure-side positioning data output:
Said infrastructure-side positioning data ⁱS is obtained from said vehicle-infrastructure trajectory matching vector x and said infrastructure-side perception data ⁱ [symbol] .

4. A method according to claim 1, wherein said calibration parameter calculation comprises the following sub-steps:
4.1) Calibration dataset initialization:
A calibration dataset [symbol] is built using said roadside positioning data ⁱS and vehicle-side positioning data ^{v}S;
4.2) Calibration parameter initialization:
An initial value for said calibration parameter X is calculated based on said calibration dataset [symbol] and said vehicle-infrastructure data delay t_{d}; An iteration upper limit m₂ is set; an iteration counter c₂ is initialized;
4.3) Calibration error calculation:
A calibration error e is calculated via said continuous trajectory representation based on said calibration dataset [symbol] and said calibration parameter X;
4.4) Calibration parameter update:
Said calibration parameter X is updated via Gauss-Newton based on said calibration dataset [symbol] and said calibration error e;
4.5) Said iteration counter c₂ is incremented by one;
4.6) If said calibration error e converges or said iteration counter c₂>m₂, said calibration parameter X is finalized; otherwise, repeat 4.3)˜4.5).

5. A method according to claim 2, wherein said calibration data collection comprises the following content:
5.1) Vehicle-side positioning data ^{v}Sₖ={^{v} [symbol] , ^{v}r}; ^{v} [symbol] denotes a vehicle-side timestamp list; vᵣ denotes a trajectory data ^{v}r={tₗ, pₗ, vₗ)|tₗ∈^{v} [symbol] }; tₗ denotes a timestamp; pₗ and vₗ denote a position and velocity in said map coordinate system \vec{F}_{M};
5.2) Vehicle-side perception data ^{v} [symbol] ₖ={^{v} [symbol] , ^{v} [symbol] , ^{v} [symbol] }; ^{v} [symbol] denotes said vehicle-side timestamp list; ^{v} [symbol] denotes a trajectory identity set; ^{v} [symbol] denotes a vehicle-side trajectory dataset ^{v} [symbol] ={(vₙ, rₙ)|vₙ∈^{v} [symbol] )}; vₙ denotes a trajectory identity; rₙ denotes a trajectory data rₙ={(tₗ, pₗ, vₗ)|tₗ∈^{v} [symbol] }; tₗ denotes a timestamp; pₗ and vₗ denote a position and velocity in said vehicle coordinate system \vec{F}_{E};
5.3) Infrastructure-side perception data ⁱ [symbol] ={ⁱ [symbol] , ⁱ [symbol] , ⁱ [symbol] }; ⁱ [symbol] denotes an infrastructure-side timestamp list; ⁱ [symbol] denotes the trajectory identity set; ⁱ [symbol] denotes the infrastructure-side trajectory dataset ⁱ [symbol] 32 {(vₙ, rₙ)|vₙ∈ⁱ [symbol] }; vₙ denotes the trajectory identity; rₙ denotes the trajectory data rₙ={(tₗ, pₗ, vₗ)|tₗ∈ⁱ [symbol] }; tₗ denotes the timestamp; pₗ and vₗ denote the position and velocity in said infrastructure coordinate system \vec{F}_{R};
said map coordinate system \vec{F}_{M} is inconsistent with said infrastructure coordinate system \vec{F}_{R}; said infrastructure-side timestamp list ⁱ [symbol] and vehicle-side timestamp list ^{v} [symbol] are inconsistent.

6. A method according to claim 3, wherein said continuous trajectory representation comprises the following sub-steps:
6.1) Synchronized timestamp calculation:
A vehicle-infrastructure data delay t_{d} is set and added to said vehicle-side timestamp list ^{v} [symbol] , obtaining synchronized timestamps ^{iv} [symbol] ;
6.2) Continuous Gaussian process modeling:
A continuous motion model and a discreate observation model are built for each trajectory data rₙ in infrastructure-side perception data ⁱ [symbol] ;
6.3) Prior state calculation:
An initial state mean μ₁ and a state covariance Σ₁ are set for trajectory data rₙ; Based on said continuous motion model, a prior state mean μ̌ and covariance Σ̌ at said infrastructure-side timestamp list ⁱ [symbol] are calculated; a prior state mean [symbol] and covariance [symbol] at said synchronized timestamp list ^{iv} [symbol] are calculated;
6.4) Calculation of posterior states at observation:
A posterior state mean μ̌ at said infrastructure-side timestamp list ⁱ [symbol] is calculated based on an observation y from said trajectory data rₙ and corresponding prior μ̌, Σ̌;
6.5) Calculation of posterior states at interpolation:
A posterior state mean [symbol] at said synchronized timestamp list ⁱ [symbol] is calculated based on said infrastructure-side timestamp list ⁱ [symbol] , said synchronized timestamp list ^{iv} [symbol] , priors μ̌, Σ̌, [symbol] and [symbol] ;
6.6) Synchronized infrastructure-side perception data output:
Said synchronized infrastructure-side perception data ^{iv} [symbol] is obtained by organizing said posterior [symbol] for each trajectory data rₙ.

7. A method according to claim 3, wherein said vehicle-infrastructure data registration and delay estimation comprises the following sub-steps:
7.1) Vehicle-infrastructure data registration:
Based on said vehicle-infrastructure trajectory matching affinity matrix A*, said vehicle-infrastructure trajectory matching vector x is obtained through a graduated non-convex concave procedure;
7.2) Vehicle-infrastructure data delay estimation:
Said vehicle-infrastructure data delay t_{d} is calculated based on said vehicle-infrastructure trajectory matching vector x, said infrastructure-side perception data ⁱ [symbol] , said vehicle-side positioning data ^{v}S and vehicle-side trajectory feature graph ^{v} [symbol] .

8. A method according to claim 4, wherein said calibration parameter update comprises the following sub-steps:
8.1) A Jacobian matrix J is calculated based on infrastructure-side trajectory data ^{f}p, vehicle-side trajectory data ^{r}p and calibration error e;
8.2) An update step ΔX is calculated based on said Jacobian matrix J and calibration error e;
8.3) Said calibration parameter X is incremented by said update step ΔX.

9. A method according to claim 7, wherein said vehicle-infrastructure data registration comprises the following sub-steps:
9.1) A graduation factor ξ is initialized; said vehicle-infrastructure trajectory matching vector x is initialized; A step length for graduation factor dξ is set;
9.2) An iteration counter c₃ is initialized; an iteration limit m₃ is set;
9.3) Step direction calculation: A step direction h is calculated based on said vehicle-infrastructure trajectory matching affinity matrix A*, graduation factor ξ and vehicle-infrastructure trajectory matching vector x; a Hungarian algorithm is applied to solve for said step direction;
9.4) Learning rate optimization: A learning rate γ is calculated using a line search algorithm based on said step direction h, said vehicle-infrastructure trajectory matching affinity matrix A*, said graduation factor ξ and vehicle-infrastructure trajectory matching vector x;
9.5) Matching vector update: Said vehicle-infrastructure trajectory matching vector x is updated using said step direction h and learning rate γ;
9.6) A graduated matching similarity measure F_{ξ}(x) is calculated based on said vehicle-infrastructure trajectory matching affinity matrix A*, said vehicle-infrastructure trajectory matching vector x and said graduation factor ξ;
9.7) Said iteration counter c₃ is incremented by one;
9.8) If said graduated matching similarity measure F (x) converges or said iteration counter c₃>m₃, sub-step 9.9) is executed; otherwise, sub-steps 9.3)˜9.7) are repeated;
9.9) Said graduation factor ξ is incremented by said step length for graduation factor dξ;
9.10) If ξ<1Λx∉Π, sub-steps 9.3)˜9.9) are repeated where Π denotes the binary vector set;
otherwise, vehicle-infrastructure trajectory matching vector x is finalized.

10. A method according to claim 7, wherein said vehicle-infrastructure data delay estimation comprises the following sub-steps:
10.1) An upper and lower bound for vehicle-infrastructure delay c, d is initialized for vehicle-infrastructure data delay; a last query position f is initialized; an iteration limit m₄ is set;
10.2) A vehicle-infrastructure trajectory matching confidence calculation function G(x, t_{d}) is defined
10.3) A second and third optimal value g_{c}, g_{d} and a last query value gr are obtained based on said vehicle-infrastructure trajectory matching vector x, vehicle-side trajectory feature graph ^{v} [symbol] , infrastructure-side trajectory perception data ⁱ [symbol] , vehicle-side positioning data ^{v}S, upper and lower bound for vehicle-infrastructure delay c, d and last query position f;
10.4) A vehicle-infrastructure trajectory matching confidence g* is calculated based on vehicle-infrastructure data delay t_{d}, and vehicle-infrastructure trajectory matching vector x through said vehicle-infrastructure trajectory matching confidence calculation function G(x, t_{d});
10.5) If g* converges or c₄>m₄, output vehicle-infrastructure data delay t_{d} and exit sub-routine; otherwise, go to sub-step 10.6);
10.6) Parameter f, g_{f}, c, d, g_{c}, g_{d} is updated by sorting the order of g_{c}, g_{d}, g_{f}, g*;
10.7) If f, g_{f}, c, d, g_{c}, g_{d} constitutes the condition for parabolic interpolation, said vehicle-infrastructure data delay t_{d} is updated using parabolic interpolation based on f, g_{f}, c, d, g_{c}, g_{d}; otherwise, said vehicle-infrastructure data delay t_{d} is updated using a golden section method;
10.8) Said iteration counter c₄ is incremented by one; go to sub-step 10.4).

11. A method according to claim 10, wherein said vehicle-infrastructure trajectory matching confidence calculation comprises the following sub-steps:
11.1) Said infrastructure-side trajectory feature graph ⁱ [symbol] is calculated through continuous trajectory representation and trajectory feature graph calculation based on said infrastructure-side perception data ⁱ [symbol] , vehicle-infrastructure data delay t_{d}, vehicle-side positioning data ^{v}S;
11.2) A delay-compensated vehicle-infrastructure trajectory matching affinity matrix A*(t_{d}) is calculated based on said vehicle-infrastructure trajectory matching vector x;
11.3) Said vehicle-infrastructure trajectory matching confidence G(x, t_{d}) is calculated based on said delay-compensated vehicle-infrastructure trajectory matching affinity matrix A*(t_{d}) and vehicle-infrastructure trajectory matching vector x.

12. A system for rapid calibration of multiple sensors in cooperative vehicle-infrastructure systems, comprising the following modules and platform:
12.1) Vehicle-side module:
Onboard positioning devices, onboard perception devices and onboard communication devices are installed on said connected vehicles;
Said onboard positioning devices collect vehicle-side positioning data;
Said onboard perception devices collect infrastructure-side perception data;
Said onboard communication devices manages communications between said vehicle-side module and an infrastructure-side module;
12.2) Infrastructure-side module:
Said infrastructure-side module involves roadside perception devices, roadside computation devices, roadside storage devices and roadside communication devices;
Said roadside perception devices collect said infrastructure-side perception data;
Said roadside communication devices manages communication between said infrastructure-side module and said vehicle-side module;
12.3) Calibration platform:
A calibration platform is deployed on said roadside computation devices, processing data collected by said vehicle-side module and infrastructure-side module, calibrating said roadside perception devices;
Said system is characterized in that it executes any of the method as claimed in claim 1˜11.

13. A system according to claim 12, wherein said vehicle-side module comprises the following devices:
13.1) Onboard positioning devices, including GNSS/IMU positioning devices, are installed on said connected vehicles, collecting vehicle-side positioning data;
13.2) Onboard perception devices, including radar, lidar and camera, are installed on said connected vehicles, collecting vehicle-side perception data;
13.3) Onboard communication devices send data to roadside communication devices.

14. A system according to claim 12, wherein said infrastructure-side module comprises the following devices:
14.1) Roadside perception devices, including radar, lidar and camera, collect raw perception data;
14.2) Roadside computation devices, processing said raw perception data, obtaining said infrastructure-side perception data;
14.3) Roadside communication devices send data to onboard communication devices.
